(19) United States
(12) Patent Application Publication
(10) Pub. No.: US 2026/0233428 A1
(43) Pub. Date: Aug. 13, 2026

(54) EXOTHERMIC WELDING SYSTEMS AND METHODS

(71) Applicant: ERICO International Corporation, Solon, OH (US)

(72) Inventors: Nicholas J. Turner, North Royalton, OH (US); Kevin Reape, Solon, OH (US); Thomas E. Bendlak, Macedonia, OH (US)

(21) Appl. No.: 19/633,303

(22) Filed: Mar. 30, 2026

Related U.S. Application Data
(63) Continuation-in-part of application No. 18/748,789, filed on Jun. 20, 2024.
(63) Continuation-in-part of application No. 18/578,532, filed on Jul. 17, 2023, now abandoned.
(60) Provisional application No. 63/509,875, filed on Jun. 23, 2023.
(60) Provisional application No. 63/389,458, filed on Jul. 15, 2022.

(51) Int. Cl. B28B 1/00; B23K 23/00; B33Y 10/00; B33Y 50/02; B33Y 70/10; B33Y 80/00

(52) U.S. Cl. CPC B28B 1/001; B23K 23/00; B33Y 10/00; B33Y 50/02; B33Y 70/10; B33Y 80/00

(57) ABSTRACT

A method of producing exothermic welding systems includes providing a digital model of an exothermic welding container to an additive manufacturing system and forming the exothermic welding container using the additive manufacturing system. For a plurality of layers, the method includes depositing a layer of a base material with a shape based on the digital model and using a phenolic resin binder to fuse the layer of the base material in the shape provided to form a corresponding part of the exothermic welding container.

### CROSS REFERENCE TO RELATED APPLICATIONS

This application is a continuation-in-part of U.S. Patent Application No. 18/748,789, filed June 20, 2024, which claims the benefit of U.S. Provisional Patent Application No. 63/509,875, filed June 23, 2023, and U.S. Patent Application No. 18/578,532, filed January 11, 2024, which is a national stage application, filed under 35 U.S.C. § 371, of International Patent Application No. PCT/US2023/070299, filed on July 17, 2023, which claims the benefit of U.S. Provisional Patent Application No. 63/389,458, filed July 15, 2022 each of which is herein incorporated by reference in their entirety.

### BACKGROUND

Exothermic welding can be used in different settings to form high quality, high ampacity, and low resistance electrical connections between different conductors. In general, an exothermic welding process can fuse together separate conductors to provide a bond with a current carrying capacity substantially equal to that of the conductors themselves. Further, exothermic welds can be relatively durable and long-lasting, and can avoid problems of loosening and corrosion that can occur for mechanical and compression joints. As a result of these benefits exothermic weld connections are widely used in grounding systems and other settings to enable connected sets of conductors to operate, effectively, as a continuous conductor with relatively low resistivity.

### SUMMARY

According to one aspect of the present disclosure, a method of producing exothermic welding systems can be provided. The method can include providing a digital model of an exothermic welding container to an additive manufacturing system. The method can include forming the exothermic welding container using the additive manufacturing system by, for a plurality of layers, depositing a layer of a base material with a shape based on the digital model and using a phenolic resin binder to fuse the layer of the base material in the shape provided to form a corresponding part of the exothermic welding container.

In some examples, the exothermic welding container can include a sidewall structure defining a welding chamber and a crucible chamber, and the exothermic welding container can further include at least one channel that extends through the sidewall structure and into the welding chamber.

In some examples, the base material can be a silica sand. The phenolic resin binder can include a furfuryl alcohol. Fusing the layer of the base material can include a polymerization reaction of the furfuryl alcohol with an acid applied to the base material.

In some examples, the base material can be a ceramic material.

In some examples, the base material can be a carbon-based material, including graphite fines. Using the phenolic resin binder to fuse the layer of the base material can include spraying the phenolic resin binder onto the base material.

In some examples, for each layer of the plurality of layers, the additive manufacturing system can apply the phenolic resin binder to a plurality of regions of the base material to fuse layers for a plurality of exothermic welding containers.

In some examples, the exothermic welding container can be formed to include one or more level markers in a riser portion corresponding to one or more fill-levels for weld material.

In some examples, the exothermic welding container can be formed as a plurality of interlocking pieces.

In some examples, the exothermic welding container can include a weld cavity having a riser section with an inverted trapezoidal cross-sectional shape, wherein a width of the riser section increases over a vertical rise moving away from a lower section of the weld cavity toward a tap hole.

In some examples, the riser section can include a first base positioned adjacent the tap hole and a second base positioned adjacent the lower section, wherein a first base width of the first base can be greater than a second base width of the second base.

In some examples, the exothermic welding container can include a retention system integrally formed during the forming, the retention system configured to secure the exothermic welding container to conductors during welding operations.

In some examples, the retention system can include slots or openings configured to receive fastening elements.

In some examples, the exothermic welding container can be configured as a cable-to-cable welding container, wherein a first channel and a second channel can be arranged in a parallel configuration to receive two conductors that extend in substantially the same direction.

In some examples, the exothermic welding container can be configured for cable-to-ground rod connections, wherein a first conductor and a second conductor can be arranged in a perpendicular or transverse orientation relative to each other.

In some examples, the exothermic welding container can include an aperture configured to receive a first conductor extending horizontally and an opening configured to receive a second conductor extending vertically.

In some examples, the exothermic welding container can be configured for cable-to-pipe connections, wherein the exothermic welding container can include a flange configured to rest against a first conductor and an aperture configured to receive a second conductor.

In some examples, a radial thickness of a peripheral wall of the exothermic welding container may not be constant along one or more internal chambers of the exothermic welding container.

In some examples, the exothermic welding container can include an opening with chamfered edges that provide a tapered entry surface to facilitate insertion of conductors.

According to another aspect of the present disclosure, an exothermic welding system can be provided. The exothermic welding system can include an exothermic welding container having a container body formed of a silica sand base material fused with a phenolic resin binder comprising furfuryl alcohol. The container body can define a crucible chamber configured to receive weld material. The container body can define a weld cavity positioned below the crucible chamber. The container body can define a tap hole extending between the crucible chamber and the weld cavity. The container body can define at least one channel extending through the container body and into the weld cavity to receive a conductor.

According to yet another aspect of the present disclosure, a method of manufacturing an exothermic welding container can be provided. The method can include generating a digital model comprising a three-dimensional representation of the exothermic welding container, the digital model defining a crucible chamber, a weld cavity, a tap hole extending between the crucible chamber and the weld cavity, and at least one conductor channel. The method can include translating the digital model into a plurality of planar layers corresponding to successive cross-sections of the exothermic welding container. For each planar layer of the plurality of planar layers, the method can include depositing a base material onto a build surface, the base material including one or more of silica sand, ceramic fines, or graphite fines. For each planar layer of the plurality of planar layers, the method can include selectively applying a phenolic resin binder to a portion of the base material in a pattern corresponding to the planar layer, the phenolic resin binder fusing the portion of the base material to form a solid layer of the exothermic welding container. The method can include repeating the depositing and selectively applying for each successive planar layer until the exothermic welding container is formed as a unitary structure corresponding to the three-dimensional representation of the digital model. The method can include removing unfused base material from the formed exothermic welding container.

### BRIEF DESCRIPTION OF THE DRAWINGS

The accompanying drawings, which are incorporated in and form a part of this specification, illustrate examples of the disclosed technology and, together with the description, serve to explain the principles of examples of the disclosed technology:

FIGS. 1-4 are isometric and elevation views of exothermic welding containers, rendered transparently to illustrate certain internal features;

FIGS. 5A-5D are perspective views of an exothermic welding system using the exothermic welding container of FIG. 3 in an exothermic welding process;

FIG. 6 is a flowchart illustrating a method for additively manufacturing an exothermic welding container according to some examples of the disclosed technology;

FIGS. 7A-7D are plan views of different layers generated from a digital model of the exothermic welding container of FIG. 3 according to some examples of the disclosed technology;

FIG. 8 is a plan view of a job box showing a plurality of layers of exothermic welding containers being concurrently printed according to some examples of the disclosed technology;

FIG. 9 illustrates a chemical reaction showing the polymerization of a furfuryl alcohol binder according to some examples of the disclosed technology;

FIG. 10 is an isometric view of an example exothermic welding container manufactured using the additive manufacturing process of FIG. 6;

FIG. 11 is an exploded isometric view of the exothermic welding container of FIG. 10;

FIG. 12 is a cross-sectional view of the exothermic welding container of FIG. 10 taken along line XII-XII of FIG. 10;

FIG. 13 is a cross-sectional view of the exothermic welding container of FIG. 10 taken along line XIII-XIII of FIG. 10;

FIG. 14 is an isometric view of another exothermic welding container manufactured using the additive manufacturing process of FIG. 6;

FIGS. 15A and 15B are exploded isometric views of the exothermic welding container of FIG. 14;

FIG. 16 is a cross-sectional view of the exothermic welding container of FIG. 14 taken along line XVI-XVI of FIG. 14;

FIG. 17 is a cross-sectional view of the exothermic welding container of FIG. 14 taken along line XVII-XVII of FIG. 14;

FIG. 18 is a cross-sectional view of another exothermic welding container manufactured using the additive manufacturing process of FIG. 6;

FIG. 19 is a cross-sectional view of another exothermic welding container manufactured using the additive manufacturing process of FIG. 6;

FIG. 20 is an axonometric view of yet another exothermic welding container manufactured using the additive manufacturing process of FIG. 6;

FIG. 21 is a side view of the exothermic welding container of FIG. 20;

FIG. 22 is another side view of the exothermic welding container of FIG. 20;

FIG. 23 is a cross-sectional view of the exothermic welding container of FIG. 20;

FIG. 24 is a first axonometric view of another exothermic welding container manufactured using the additive manufacturing process of FIG. 6;

FIG. 25 is a second axonometric view of the exothermic welding container of FIG. 24;

FIG. 26 is a cross-sectional view of the exothermic welding container of FIG. 24;

FIG. 27 is a side view of the exothermic welding container of FIG. 24;

FIG. 28 is a first axonometric view of yet another exothermic welding container manufactured using the additive manufacturing process of FIG. 6;

FIG. 29 is a second axonometric view of the exothermic welding container of FIG. 28;

FIG. 30 is a cross-sectional view of the exothermic welding container of FIG. 28; and

FIG. 31 is a side view of the exothermic welding container of FIG. 28.

### DETAILED DESCRIPTION

Before any examples of the disclosed technology are explained in detail, it is to be understood that the disclosed technology is not limited in its application to the details of construction and the arrangement of components set forth in the following description or illustrated in the following drawings. The disclosed technology is capable of other implementations and of being practiced or of being carried out in various ways. Also, it is to be understood that the phraseology and terminology used herein is for the purpose of description and should not be regarded as limiting.

The following discussion is presented to enable a person skilled in the art to make and use examples of the disclosed technology. Various modifications to the illustrated examples will be readily apparent to those skilled in the art, and the generic principles herein can be applied to other examples and applications without departing from the disclosed technology. Thus, the disclosed technology are not intended to be limited to examples shown, but are to be accorded the widest scope consistent with the principles and features disclosed herein. The following detailed description is to be read with reference to the figures, in which like elements in different figures have like reference numerals. The figures, which are not necessarily to scale, depict selected examples and are not intended to limit the scope of examples of the disclosed technology. Skilled artisans will recognize the examples provided herein have many useful alternatives that also fall within the scope of the disclosed technology.

As noted above, exothermic welding can be used to connect metal structures, such as copper conductors of an electrical system. Generally, exothermic mixtures can include a combination of a reductant metal and a transition metal oxide, which react exothermically upon ignition to supply sufficient heat to propagate and sustain a continuing reaction of the mixture. The resulting heat can be used directly or the resulting molten metal can be used to create a useful weld, as in the case of exothermic welding.

As one example, some conventional exothermic weld material mixtures can include aluminum and copper oxide. Upon ignition, the resulting exothermic reaction can provide a mixture of molten copper and aluminum oxide (the latter being commonly referred to as “slag”). The molten copper has a higher density than the slag and can accordingly be caused by gravity to flow within a mold to weld together metal conductors (e.g., copper to copper or steel to steel). The less dense aluminum oxide slag is generally removed from the weld connection, or from other parts of the mold in which it may accumulate, and is discarded. As another example, other conventional mixtures can include iron oxide and aluminum, which can react with similar effect.

Exothermic mixtures of this type do not react spontaneously and need a method of initiating the reaction, which involves generating enough localized energy to enable the exothermic reaction to begin. One typical method of initiating ignition is through use of starting powder and an ignition source such as an electric igniter or a flint igniter.

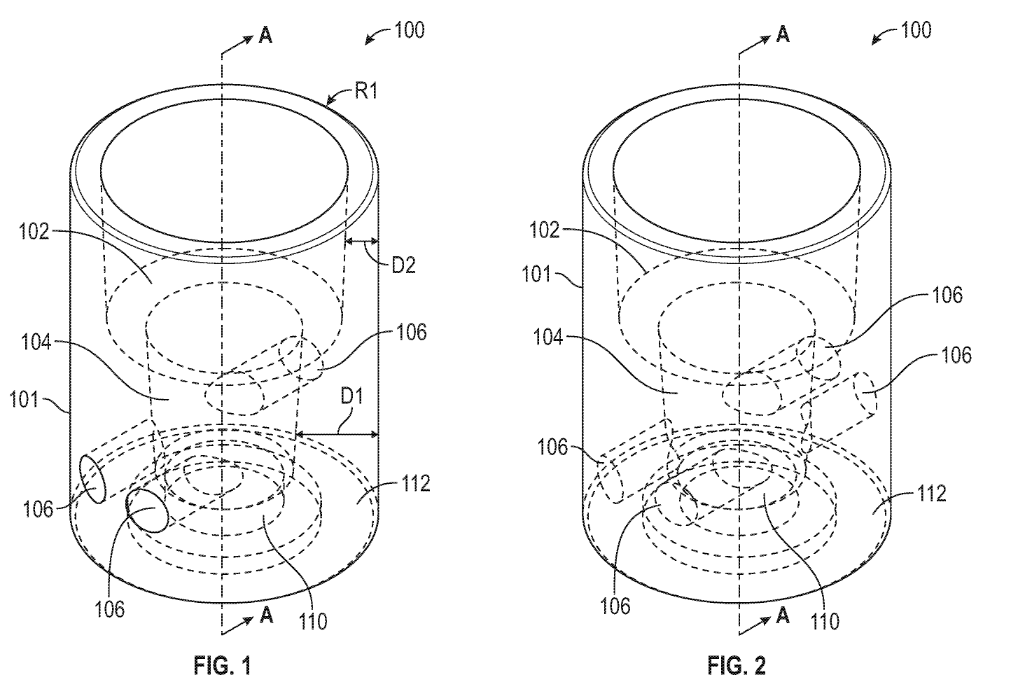

Exothermic welding containers (e.g., molds) can be provided to contain exothermic reactions, and to weld conductors in a desired configuration. For example, FIG. 1 illustrates an exemplary exothermic welding container 100, having a radial sidewall 101 (e.g., as can be manufactured using the methods detailed below). As shown, the exothermic welding container 100 can be generally tubular having an outer radius R1 and defining internal regions for containing the exothermic reaction and forming the weld. Although the example mold exhibits radial symmetry and generally circular cross-sectional profiles, other types of sidewall structures are possible in other examples.

In some examples, a crucible chamber 102 can be provided in an upper portion of the exothermic container 100, and a welding chamber 104 can be defined in a lower portion of the container 100. The welding chamber 104 and the crucible chamber 102 can have different volumes that can in some cases correspond to a thickness of the radial sidewall 101. For example, as shown in FIG. 1, the radial sidewall 101 can have a thickness D1 along the welding chamber 104, and a thickness D2 along the crucible chamber 102. The thickness D1 can be greater than D2, and can generally determine a molded shape for a resulting weld while also providing thermal conditions advantageous for creating a quality weld in the welding chamber 104. In some examples, a thickness of the radial sidewall 101 can vary along a radial or along an axial dimension, which can produce thermal conditions for exothermic welding containers of different configuration to produce quality welds.

To accommodate conductors (to be welded), channels 106 can be provided in the radial sidewall 101 of the container 100. The channels 106 can extend radially through the sidewall 101, transverse to a radial axis A of the container 100, and can further open into, and be continuous with, the welding chamber 104. Conductors (e.g., steel wires, copper wires, etc.) can be inserted through the channels 106 into the welding chamber 104, and can thus, for example, be positioned to be welded together with other conductors that are inserted through other channels 106 into the weld chamber 104.

In some cases, a welding container can define an opening for a ground rod, to facilitate the exothermic welding of conductors to the ground rod. For example, in FIG. 1, an opening 110 is defined in a bottom surface 112 of the container 100, into which a ground rod can be received. As shown, the opening 110 can be coaxial with the crucible chamber 102 and the welding chamber 104, and can be positioned beneath and open into the welding chamber 104. The illustrated container 100 shows three channels 106 and one opening 110 for a ground rod, and an exothermic weld performed in the container can thus weld three conductors to a ground rod. However, other configurations are possible, including as illustrated in FIG. 2, which shows an exothermic welding container 100 that is generally similar to the exothermic welding container 100 of FIG. 1, but includes four channels 106 for receiving conductors, the channels being positioned on opposite sides of the radial sidewall 101.

In other configurations, an exothermic welding container could have any number of channels, as may correspond to the particular welded configuration to be obtained. Further, one or more channels of an exothermic welding container can be differently positioned than those illustrated in FIGS. 1 and 2. In some cases, for example, some channels be positioned at right angles relative to other channels, or could be offset from other channels in a direction parallel to an elongate axis A of a mold (or other reference line). Further, an exothermic welding container may not include an opening for a ground rod, and could instead be configured only for welding conductors together through one or more the channels in the side wall.

Exothermic welding containers can additionally be configured to accommodate conductors of differing widths. For example, FIGS. 3 and 4 illustrate exothermic welding containers 100 with channels 106 of differing widths. In particular, in the illustrated example, the channel 106 of FIG. 3 has a width D3 that is larger than the width D4 of the channels 106 of the exothermic welding container 100 shown in FIG. 4. However, other configurations are possible in other examples. Indeed, in this regard, electrical connections may require that any number of different conductors, of a variety of different diameters, be welded together or welded to a ground rod in a variety of different positions. It may thus be useful to provide exothermic welding containers for a wide variety of different welding configurations, including, for example, the configurations illustrated in FIGS. 1-4 and various others. However, conventional methods of producing exothermic welding containers may include a significant cost for manufacturing exothermic welding containers having different configurations, and it may therefore be impractical or cost-prohibitive to produce exothermic welding containers for some applications using conventional methods.

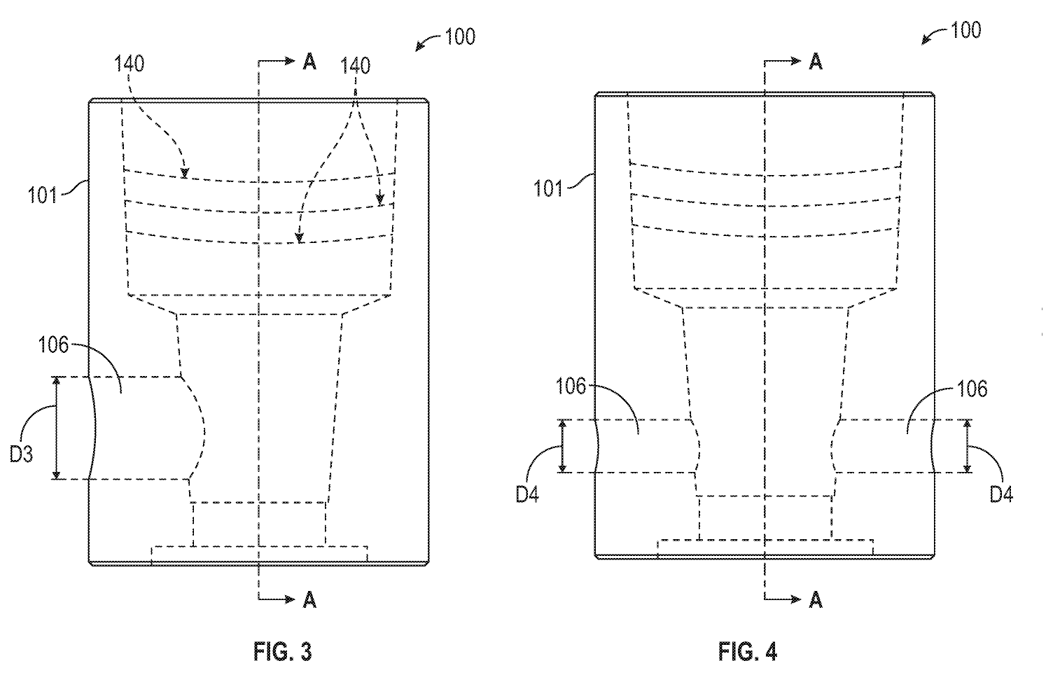

FIGS. 5A-5D illustrate a conventional exothermic welding process using an example conventional configuration of the exothermic welding container 100 (e.g., similar to as shown in FIG. 3). In some cases, conventional exothermic welding containers can be single-use molds, which can be removed from the welded connection by breaking the mold after the exothermic welding reaction. As shown in FIG. 5A, a conductor 114 can be inserted into the channel 106, and a ground rod 116 can be inserted into the corresponding opening 110 (not shown in FIGS. 5A-5D) of the container 100. FIG. 5A illustrates a crucible chamber 102 of the container, with a plate 118 separating the crucible chamber 102 from the welding chamber 104 (not shown in FIGS. 5A-5D). The crucible chamber can be filled with weld material and, as shown in FIG. 5B, a lid 120 may be placed over the crucible chamber 102 to prevent the escape of particulate matter from the container 100 during the exothermic reaction. Starting material 122 may be added through an aperture 124 of the lid 120, and along a top surface of the lid 120, and can be ignited to initiate the exothermic reaction.

As discussed above, during the reaction, the weld material is changed to molten metal. The heat from the reaction melts the plate 118, and the force of gravity causes the molten metal to flow into the welding chamber 104 to join the ground rod 116 to the conductor 114. Once the weld has been completed, the mold may be broken off the welded connection and the connection cleaned or otherwise processed as appropriate. In this respect, FIG. 5C illustrates the exothermic welding container 100 partially broken off of a welded connection of the ground rod 116 and the conductor 114, with only a lower portion of the exothermic welding container 100 remaining. FIG. 5D then illustrates the resultant welded connection of conductor 114 and ground rod 116, with the mold 100 completely removed (e.g., broken free and discarded).

Conventional exothermic welding containers, including a single-use mold (e.g., as illustrated in FIGS. 5A-5C), can be manufactured using conventional subtractive manufacturing methods. Some conventional methods for manufacturing exothermic welding containers can utilize manufacturing molds (e.g., cordierite molds) into which the material for the exothermic welding containers can be press-fit. The molds can generally define an inverse of the shape of the exothermic welding container, with different molds being required to produce exothermic welding containers of different shapes or configurations. Thus, for example, in some conventional methods, producing an exothermic welding container having different dimensions (e.g., a different external radius, different thicknesses of the radial wall, etc.) necessitates the use of a different manufacturing mold. Similarly, a difference in a thickness of a peripheral wall may also require the use of a different mold. Correspondingly, conventional systems may exhibit relatively high cost for producing exothermic welding containers of different configurations, as any change in dimensions of an exothermic welding container may require the production of new tooling to manufacture the container. There is therefore a need in the art for a method of producing a wide range of configurations of exothermic welding containers, including as may not incur substantial additional tooling costs.

Conventional methods may also impose undesirable limitations on the materials that may be used to produce exothermic welding containers. For example, conventional exothermic welding containers may be manufactured by molding or machining a ceramic material. Such an approach may provide a heat-resistant container for containing an exothermic reaction, but the container may be unusable after a single reaction (i.e., may be a single-use container). It may therefore be desirable to use manufacturing methods by which different materials could economically be utilized to produce exothermic welding containers, including containers that could be used more than once.

It may also be desirable to use materials having different properties, which could, for example, facilitate the production of molds that could accommodate weld configurations with different thermal profiles. For example, thermal profiles within a welding chamber of a conventional exothermic welding container may not be conducive to certain welding configurations and could produce a lower-quality weld in those configurations. Adjustments may be required to the dimensions of an exothermic welding container to make a container suitable for producing high-quality welds given different welding configurations, or different materials. As an example, a different thickness may be required in a section of the radial wall to generate a heat profile that is suitable for a given welding configuration. The required thickness or dimensions of a weld chamber of an exothermic welding container may differ based on the material used to produce the mold.

In this light, conventional manufacturing methods impose practical limitations on materials that may be used in producing exothermic welding containers, or on dimensional adjustments that may be necessary to accommodate differently configured welds. In particular, each dimensional variation would require the creation of a new manufacturing mold for the new configuration, which may not be economically practical or otherwise workable.

Conventional methods for manufacturing exothermic welding containers can further impose manufacturing costs for producing different configurations of containers, even where the different configurations do not require the use of new molds or tooling to produce. For example, in some conventional methods, channels in a peripheral wall of the container for receiving conduit (e.g., channels 106) can be produced through subtractive manufacturing methods (e.g., drilling). This can impose additional material costs by requiring the container to first be produced with extraneous material that will then be removed to generate the desired configuration. Further, the described conventional method may impose still more manufacturing costs by requiring an additional precise rotation of a container during the manufacturing process to correctly position the container for drilling an additional channel.

Producing channels of different diameters may also impose additional manufacturing costs by introducing the need to use additional tooling to drill a channel of the requisite diameter, which can also necessitate further rotation of the mold during manufacturing. This additional manipulation of the container during manufacturing, as well as the drilling required may produce defects in some containers due to variation in alignment, for example. There is thus a need in the art for a method of manufacturing exothermic welding containers that allows different configurations of a container to be manufactured without the need for additional tooling, and further allows containers to be manufactured in a manner that does not require subtractive manufacturing methods, which can impose additional material costs and introduce error and defects in the manufacturing process.

To address these and other difficulties inherent in conventional systems, improved methods for manufacturing an exothermic welding container can be provided. According to some examples, methods (and related systems) can be provided for manufacturing an exothermic welding container, including methods to additively manufacture an exothermic welding container based on a digital model that includes a three-dimensional representation of an exothermic welding container. In some examples, such production can result in an exothermic welding container that is usable as-is, although other examples may require or benefit from various post-machining processes (e.g., smoothing, boring, grinding, etc.)

A variety of additive manufacturing systems are generally known in the art, with some examples configured in particular as binder jet systems. Binder jet systems typically include a nozzle or other assembly to deposit binder, and sub-systems of various known types to add to or remove from a containing vessel (herein, a “job box”) base material that includes loose powder of various types (e.g., for exothermic welding containers, a silica sand, ceramic fines, or graphite or other carbon fines). These systems can accordingly operate by systematically depositing a base material containing loose powder into a job box, and selectively applying a binder (e.g., an adhesive) to the base material in accordance with the digital model (i.e., with the binder being deposited in a pattern corresponding to the solid form of the corresponding layer of the product being manufactured). Thus, the deposited binder can cure the base material together, where applied, to produce a corresponding solid layer of the relevant product (e.g., exothermic welding container). This process can then be repeated for a number of layers, until the relevant product (e.g., exothermic welding container) has been produced, corresponding to the three-dimensional representation of the digital model.

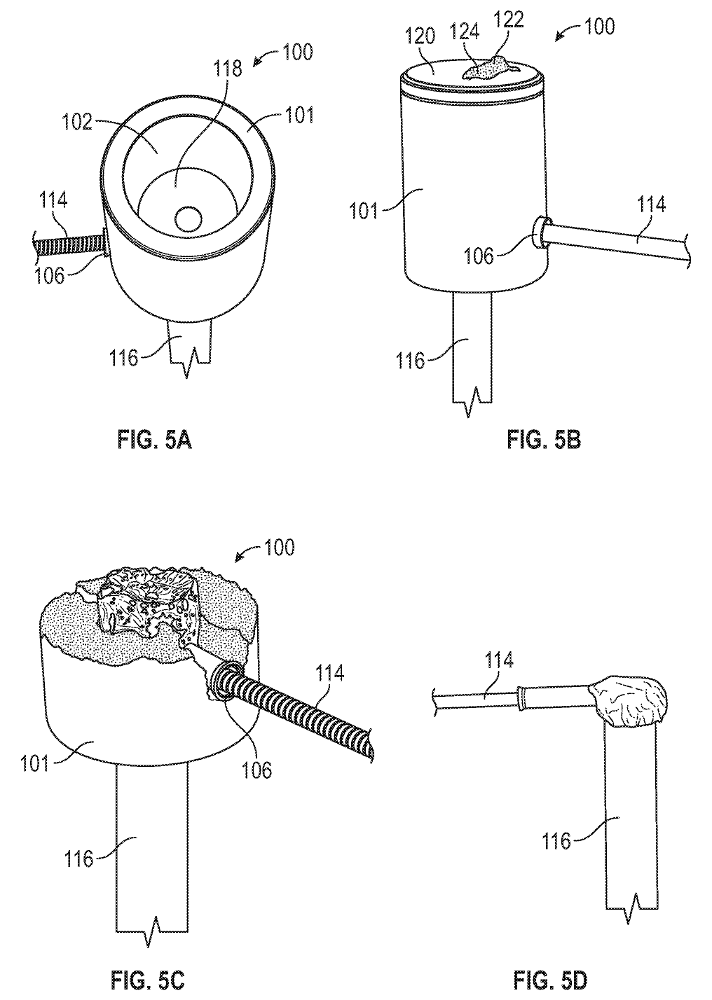

In this regard, FIG. 6 illustrates an exemplary process 200 for manufacturing an exothermic welding container which can mitigate (e.g., eliminate) the above-mentioned problems with conventional manufacturing methods. The process 200 can be a binder jet printing process, which can provide a benefit in allowing for simultaneous printing of a production volume of exothermic welding containers. In other examples, other printing method can be used, including but not limited to fused filament fabrication (FFF), Fused Granulate Fabrication (FGF), direct ink writing (DIW), electrospark deposition (ESD), and directed energy deposition (DED) using laser, plasma, arc, plasma transferred arc, electron beam, or exothermic reaction as heat sources, and ink, filament, pellets, powder, or wire as feedstocks.

As illustrated, at operation 202, a computer model of an exothermic welding container can be generated. This computer model may include a three-dimensional digital representation of an exothermic welding container, including dimensions and configurations of the exothermic welding container, e.g., a thickness of a peripheral wall, a number, dimension, and orientation of conductor or other channels, an orientation, size, and shape of a tap hole or rise, a shape and size of a welding or crucible chamber, a dimension of a ground rod opening, etc. In some examples, the model can include digital representations of any of the containers 100 illustrated in FIGS. 1-4. In other examples, the digital model can include a digital representation of containers of other configurations, including, for example welding configurations with more than the four channels 106 or with the channels 106 being oriented at different radial (or other) angles with respect to each other, or configurations without a ground rod aperture.

In some cases, the digital model can include digital representations of containers with geometries that may allow the container to be removed from a welded connection without the need to break the container off of the connection, as shown, for example, in FIG. 5C. For example, the exothermic welding container could be printed in two halves that can be temporarily joined during a welding operation with the use of clamps, fasteners, or any other method known in the art for temporarily securing one component to another. In some cases, digital models (and the resulting molds) can include multiple pieces with interlocking components (e.g., press-fit or bayonet-engagement features) that can be used to secure the pieces together for welding operations.

In some cases, models can include different features or dimensions based on the material to be used to produce the container. In some examples, a thickness of the weld chamber can be adjusted in a digital model to produce a thermal profile in a weld chamber that can produce a high-quality weld given the material used to produce the container.

At operation 204, the digital model can be provided to an additive manufacturing system (e.g., of the various types noted above), which can translate the model into instructions for producing the exothermic welding container. For example, an additive manufacturing system may convert a digital model of a three-dimensional exothermic welding container into a number of layers that may be successively printed to produce the exothermic welding container. In some cases, a digital model can be created using an additive manufacturing system. In some cases, a digital model can be pre-made and a relevant method can include simply using – e.g., rather than necessarily generating – the pre-made model in combination with an additive manufacturing system.

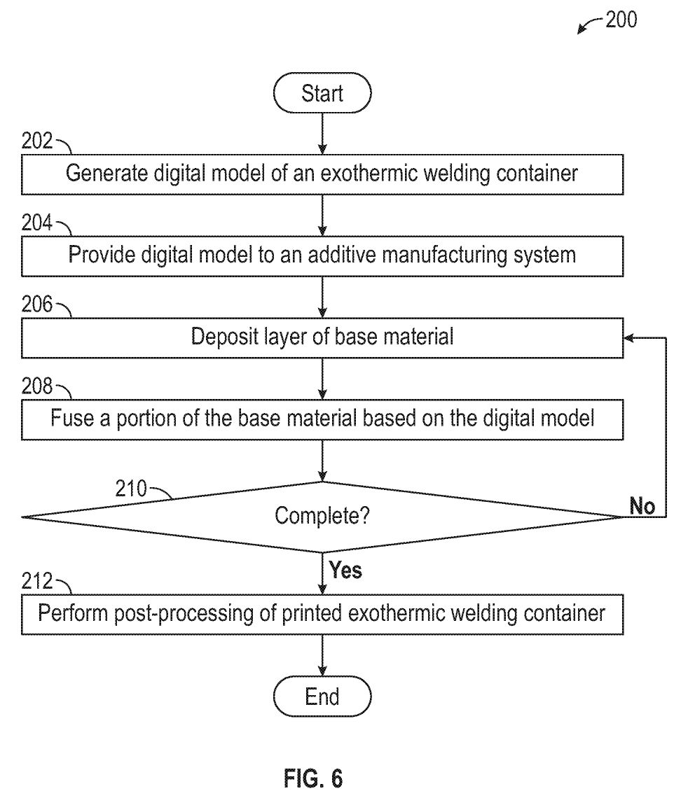

Further regarding the layers noted above, FIGS. 7A-7D illustrate exemplary planar layers 150 of a digital model for an exothermic welding container (e.g., exothermic welding container 100). For example, FIG. 7A shows a planar layer 150A of the digital model. In particular, the planar layer 150A can be a layer that includes the opening 110 for the ground rod, defined in the bottom surface 112. FIG. 7B illustrates a planar layer 150B, which, as shown, is a layer of the exothermic welding container 100 along the weld chamber 104 (and can correspondingly be deposited above – and, e.g., after – the layer 150A). In layer 150B, the radial wall 101 thus has the thickness D1. FIG. 7C illustrates another planar layer 150C which is another layer of the weld chamber but further includes a portion of the channel 106, having the diameter D3 (e.g., as shown in FIG. 3). FIG. 7D illustrates planar layer 150D which is a planar layer of the crucible chamber 102, with the radial wall 101 having the thickness D2.

Referring back to FIG. 6, at operation 206, the additive manufacturing system can deposit a level of base material for the exothermic welding container. In particular, the material deposited by the additive manufacturing system can include a material of which the exothermic welding container will ultimately be composed (e.g., in addition to a binder or other material that may not be preserved in the final mold).

In some examples, the deposited material can be a silica sand, e.g., with the silica sand evenly deposited along a planar surface of a relevant layer. In some examples, the deposited material can be a carbon material (e.g., graphite) or can be a ceramic material (e.g., semi-crystalline alumina silicate, sintered bauxite, etc.). Powder used as a base material for an additive manufacturing system can alternatively be referred to as “fines,” and base material can thus include, for example, graphite fines, ceramic fines, aluminum fines, etc. In some examples, the use of ceramic fines can provide an exothermic welding container of particular resilience and overall strength. In some examples, the use of a carbon-based material (e.g., graphite fines) can enhance a heat resistance of the exothermic welding container, and can more readily allow for the manufacturing of multi-use exothermic welding containers. In some examples, it may be beneficial to use fines (e.g., graphite fines) with an average particle size of 100 fineness, as specified by the Fineness Number system of the American Foundry Society.

The layers of the digital model can be used as instructions for the additive manufacturing system to produce an exothermic welding container. For example, at operation 208, a portion of the base material can be fused, in accordance with the instructions generated for the digital model. For example, for a given layer of base material, a binder can be applied to a portion of the layer to fuse a portion of the base material together, which can produce at least a portion of the exothermic welding container. In some examples, the binder can be applied in a planar layer having one of the profiles shown in FIGS. 7A-7D. In any case, the portion of the powder to which the binder is applied can generally then be cured to form a solid portion of the exothermic welding container.

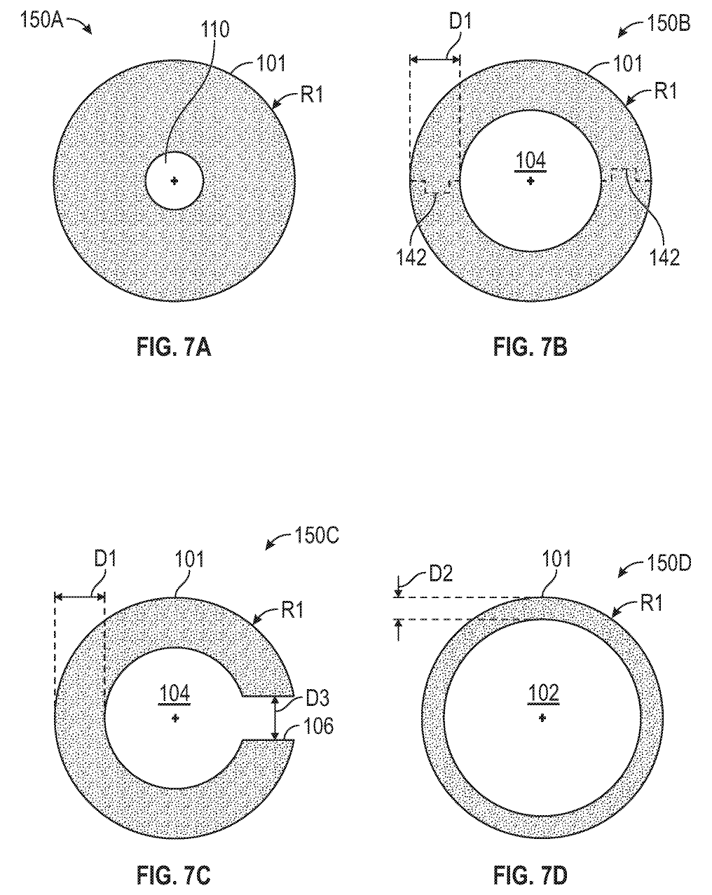

In some examples, as shown in FIG. 8, a base material 160 can be deposited on a planar surface 162 of a job box 164 (or other workspace), having a length and width that can accommodate the simultaneous manufacturing of multiple exothermic welding containers 100. As illustrated, for example, a binder can be applied to the base material 160 to fuse a planar layer 150 of the base material 160 for a plurality of exothermic welding containers 100 along the planar surface 162. In this regard, the job box 164 can have a depth that is equal to or greater than a height of the exothermic welding container 100, to allow for base material 160 to be deposited at a sufficient depth to produce the exothermic welding container 100. After the first layer of base material 160 has been deposited onto the planar surface 162, the next layer of base material 160 can be deposited on the previously deposited base material 160, which can comprise a planar surface parallel to the planar surface 162.

In this regard, referring back to FIG. 6, at operation 210, the process 200 can check a completion of the additive manufacturing process for the exothermic welding container or plurality of exothermic welding containers 100. For example, printing the exothermic welding container 100 can require iteratively depositing and fusing the base material, and the number of iterations can correlate to the number of layers into which the digital model is divided in operation 204. At operation 210, then, the additive manufacturing system can check if the number of iterations of depositing and fusing is equivalent to the number of planar layers of the exothermic welding container (or otherwise determine whether all layers have been created). If the system has not performed a deposit and fusing (or other relevant operation) for each layer, the system can repeat operations 206 and 208 until a depositing and fusing operation has been performed for each layer. Upon completion of the printing operations, as desired, the resultant printed exothermic welding container or containers 100 can thus be substantially identical to the three-dimensional representation provided in the digital model at operation 202.

In some examples, a binder for an additively manufactured mold can be a furan resin material (e.g., furfuryl alcohol). In this case (or others), when constructing the exothermic welding container, the base material can be coated with an activator. In some examples, the activator can be an acid. To fuse the layers 150 of the exothermic welding container 100, or plurality of exothermic welding containers 100 (e.g., as shown in FIG. 8), a component of the binder can be added (e.g., sprayed) onto the base material coated in the activator. For example, as noted above, the added binder component can be a furfuryl alcohol. When the furfuryl alcohol (or other binder component) contacts the activator, this can initiate a chemical reaction to produce a suitably bonded mold body.

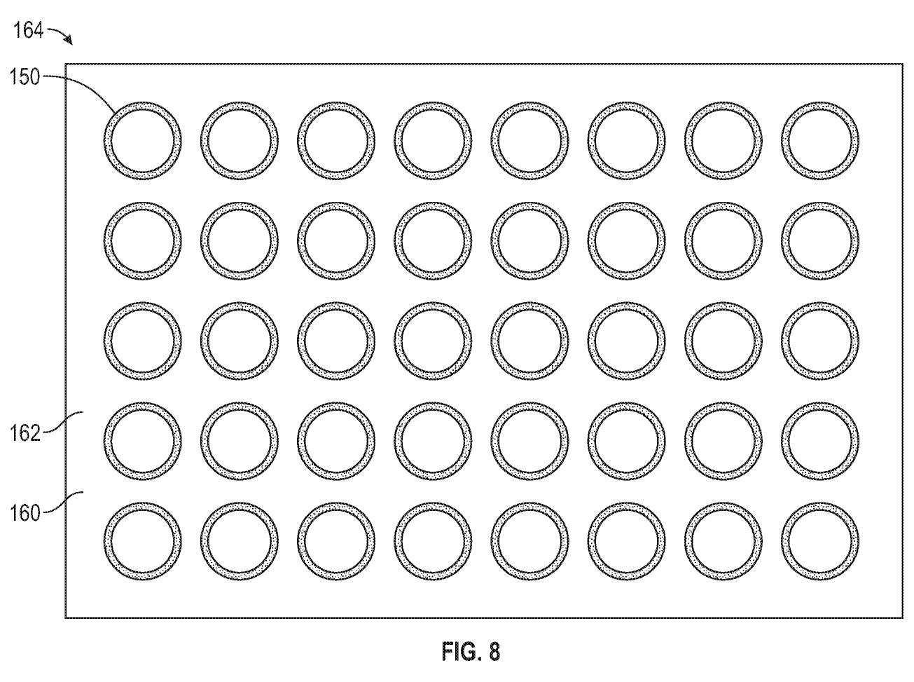

An example reaction for curing a suitable binder is illustrated in FIG. 9. As shown, the reaction can be a polycondensation reaction of a furfuryl alcohol 170. When the activator comes in contact with the binder (e.g., when the furfuryl alcohol is sprayed onto the base material), a polycondensation reaction shown in FIG. 9 proceeds. In the above example of the polycondensation of furfuryl alcohol, the hydroxide (OH) functional group leaves the furfuryl alcohol molecule due to the proton donation of the acid activator catalyst. The resulting methylfuran monomers 172 are then able to polymerize and form a long chain polymer with the formation of water as a byproduct. The polymerization fuses the sprayed portion of the base material 160, forming a solid portion of the base material 160 that constitutes a part of an exothermic welding container 100.

In some cases, using a base material of silica sand with a furan resin binder, as described, can be advantageous, as it can chemically cure the portions of the exothermic welding container without the need for post processing heat treatment. This approach can thus further reduce a cost of producing exothermic welding containers. In other examples, however, a base material and binder or adhesive used to additively manufacture an exothermic welding container can require additional heat treatment to cure the printed container after the container is printed. Similarly, although particular chemicals and deposition techniques are described in the examples above, other examples can include other chemicals or utilize other processes to additively manufacture a mold.

In this regard, for example, the binder for an additively manufactured mold can be a phenolic resin polymer, which may be substituted for the furan resin material in the process above, or could react with other activators (or with no activators) to bind portions of the base material together. In particular, a phenol formaldehyde resin (or, herein, simply “phenol resin”) can be formed as a thermosetting polymer that can be cured simply by the application of sufficient heat energy. Correspondingly, for example, manufacture of an exothermic welding container with phenol resin can be accomplished without applying a catalyst or other additional material to any particular layer, once the resin binder is deposited onto the base material in a relevant pattern for any given layer. In some examples, phenol resin binder can be used with silica base material, which can provide improved resilience relative to the heat of a welding process than a similar configuration using furfuryl alcohol and an activator. In some example, phenol resin binder can be used with ceramic or carbon-based (e.g., graphite) fines.

Referring again to FIG. 6, once the additive manufacturing operation has completed, post-processing activities can be performed (as operation 212) on the printed exothermic welding containers. For example, over the course of printing, a job box containing the printed exothermic welding containers 100 may also be filled with unfused base material that was deposited in operation 206. The unused based material may need to be drained from the job box so that the printed exothermic welding containers 100 can be removed from the job box, or, alternatively, the printed containers 100 can be removed directly. Other post-processing operations may also be used in some cases, including operations to remove base material residue from the printed containers 100. In some examples, further treatment, including heat treatment or application of a coating to the printed containers 100 may be completed before the exothermic welding containers 100 are used for welding connections.

In some examples, additive manufacturing processes (e.g., as described above) can be used to introduce other features into a mold for exothermic welding. In some cases, a portion of a mold can be formed to include demarcations that can assist users in appropriately filling or assessing a fill-level of the mold for welding operations. For example, fill lines 140 can be formed in a riser portion of a mold as shown in FIG. 3, or at other locations. As another example, as also noted above, interlocking features (e.g., interlocking protrusions) can be formed into different parts of a mold, and can thereafter be used to join the parts together for welding operations .For example, keyed interlocking features 142 can be provided, as shown in FIG. 7B (e.g., for press-fit inter-engagement). As another example, any one or more of a filter structure for a welding container can be formed by additive manufacturing, as can attachment features for handles, clamps, separate crucibles, etc.

Thus, examples of the disclosed technology can provide substantially improved manufacturing methods for exothermic welding systems. For example, using the manufacturing method disclosed, exothermic welding containers can economically be produced for multiple welding configurations without the need for specialized tooling or processing for each configuration, and the attendant cost. Additionally, the disclosed methods can allow for dimensions of an exothermic welding container to be varied at little cost, to thereby economically produce a thermal profile appropriate for a variety of different materials and configurations, and can allow for the manufacturing of exothermic welding containers using a variety of materials with corresponding benefits (e.g., for multiple-use graphite containers, rather than conventional single-use containers).

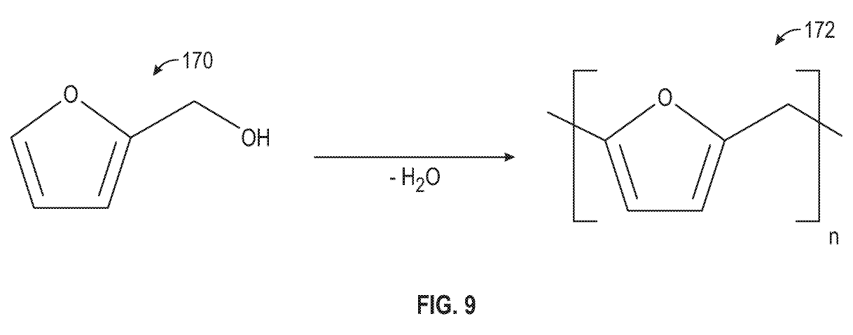

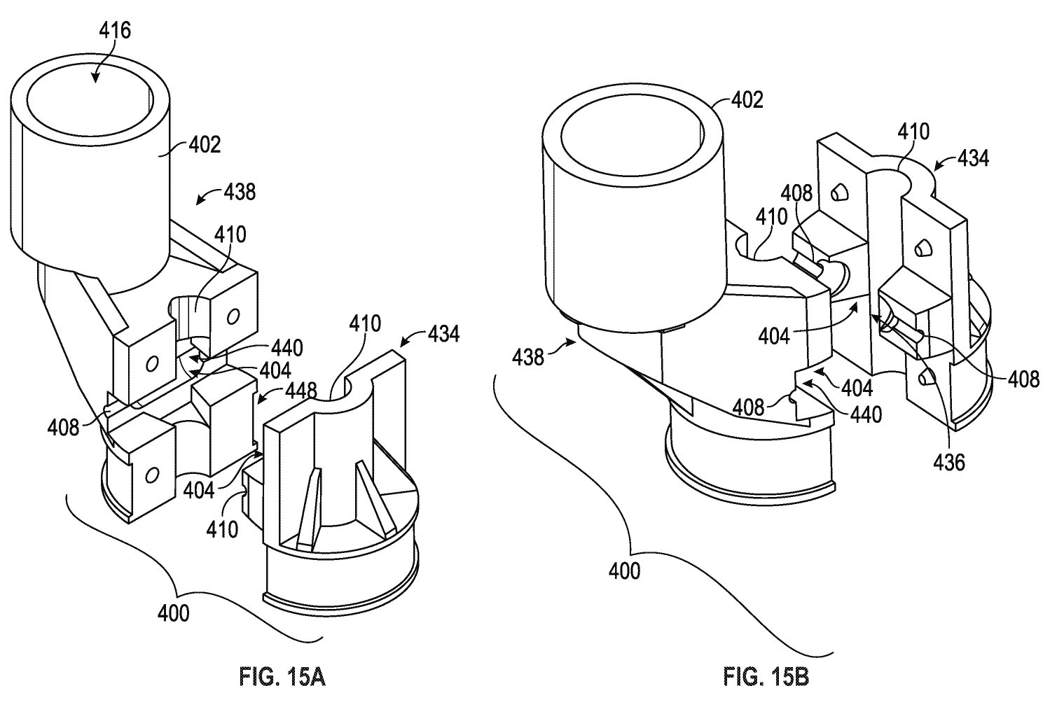

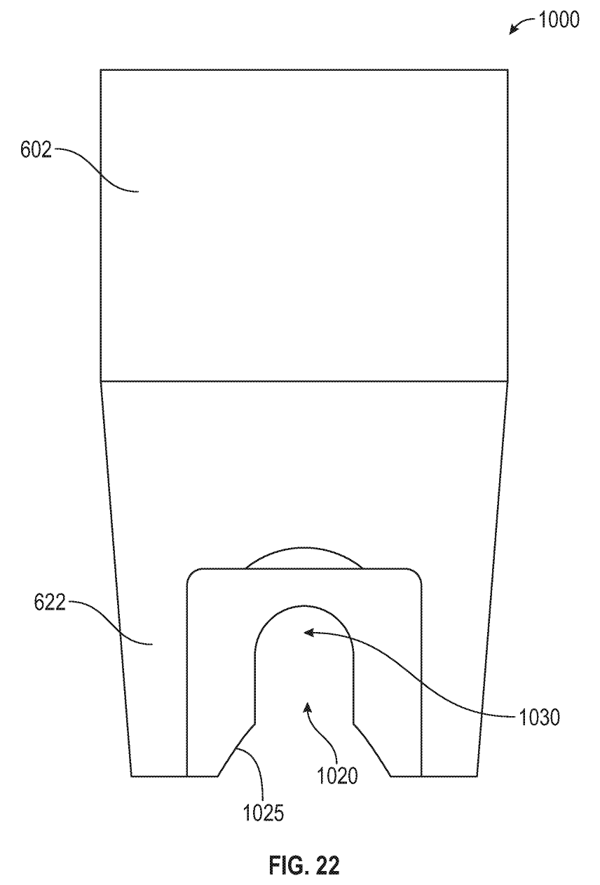

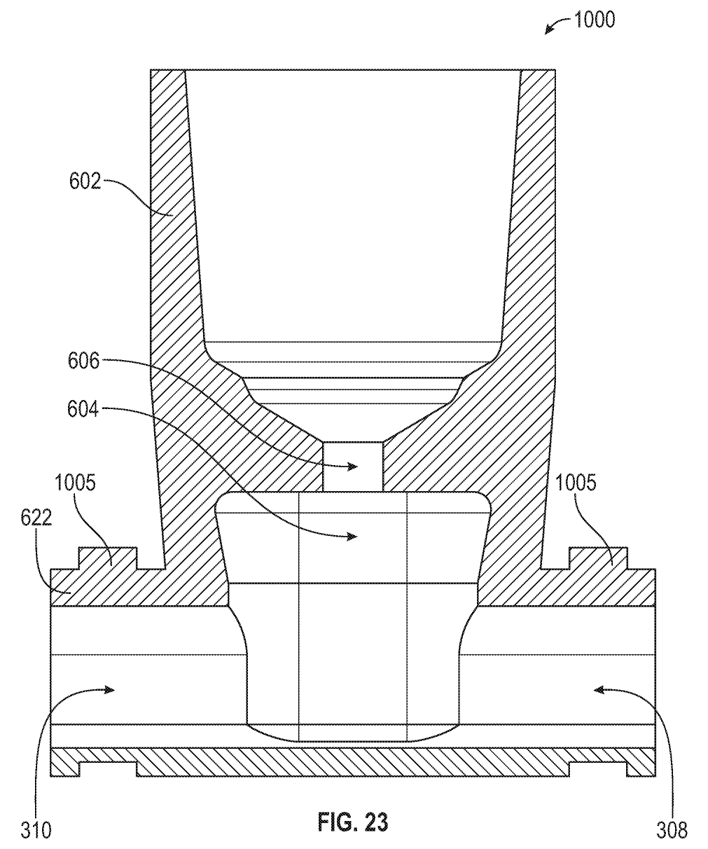

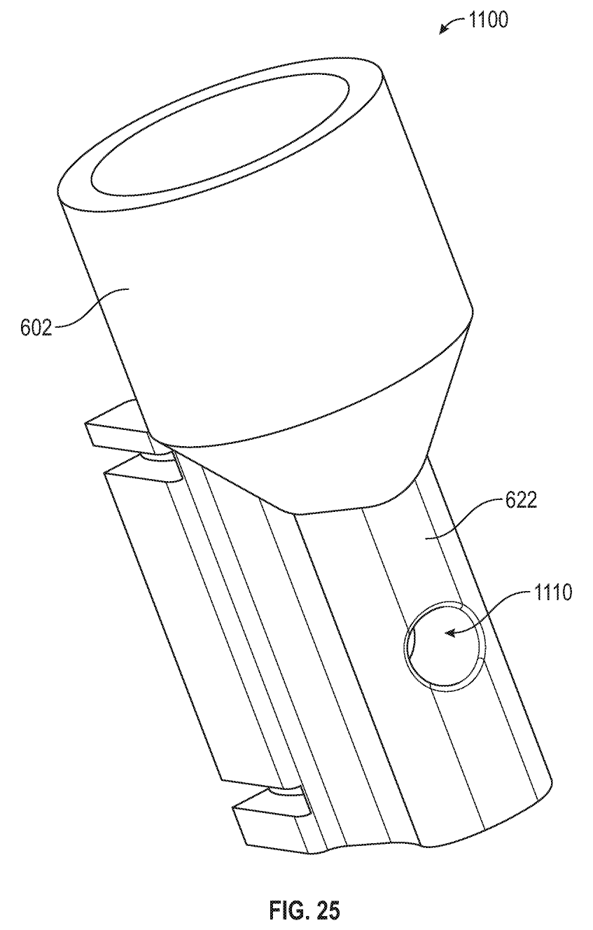

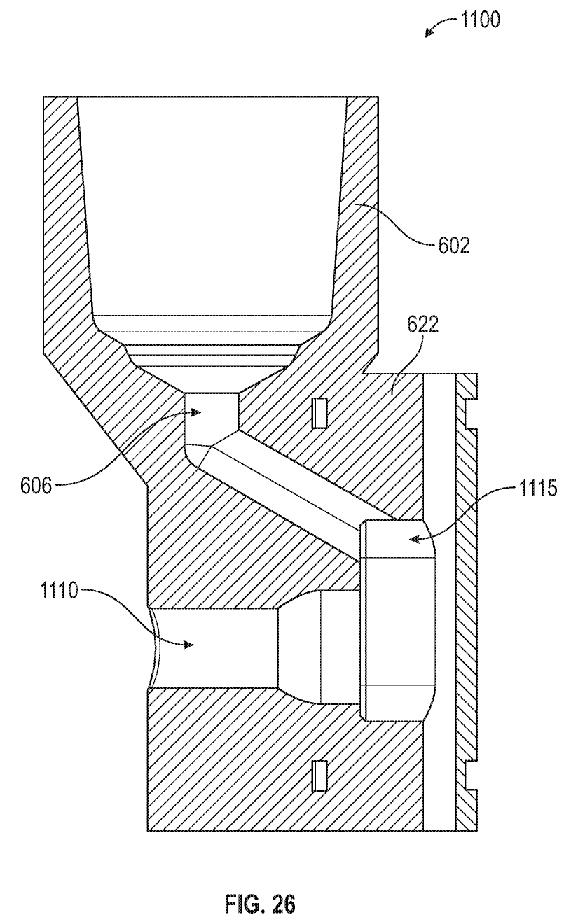

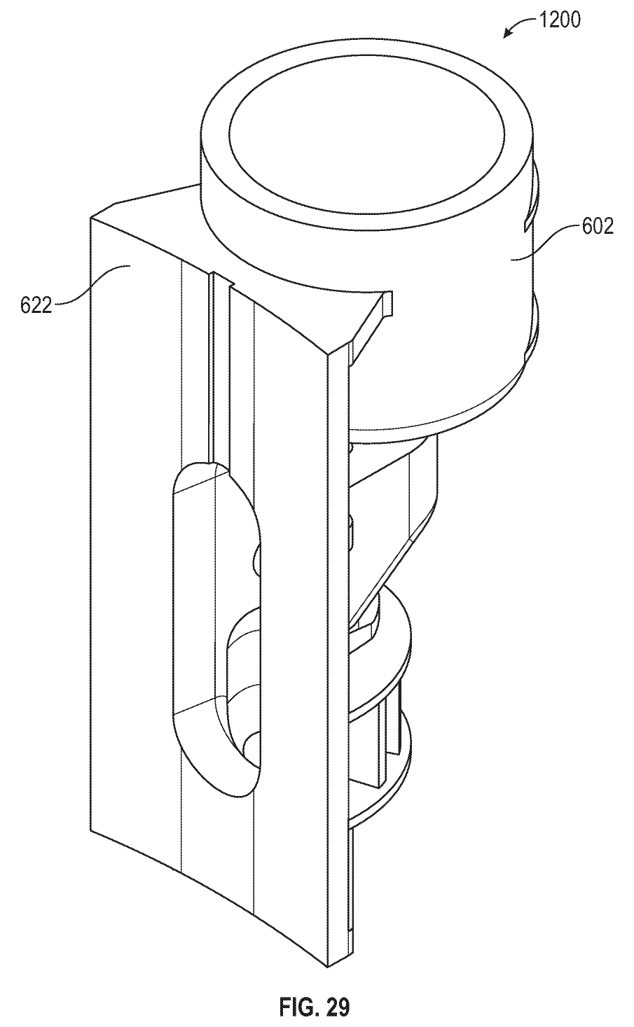

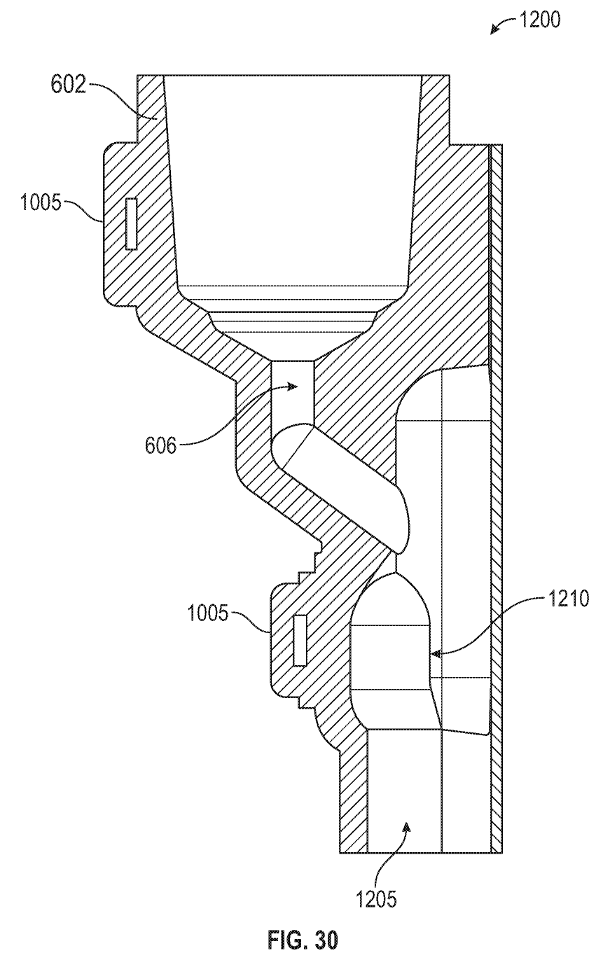

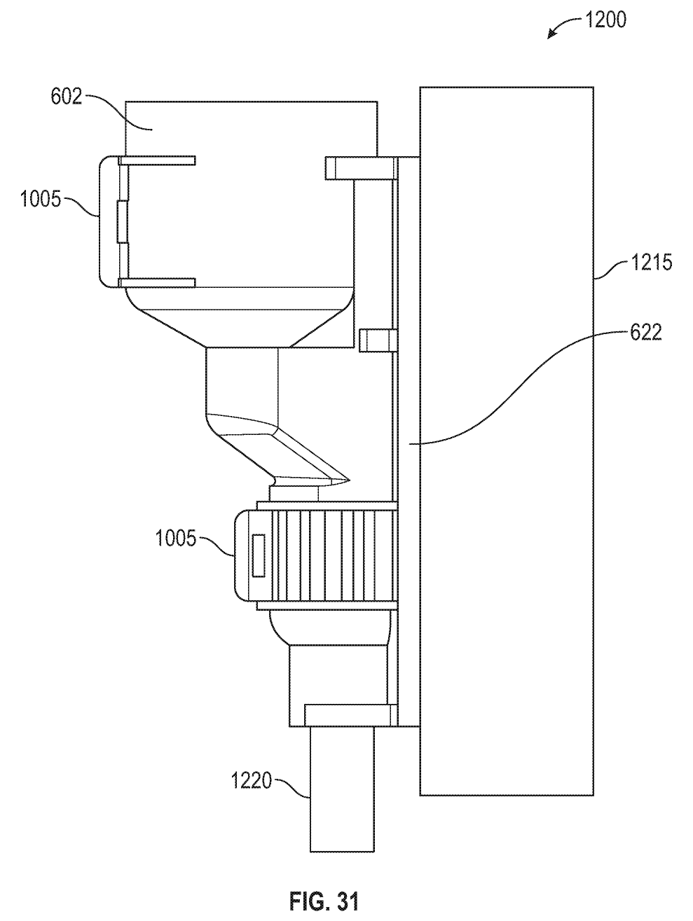

FIGS. 10-31 illustrate various examples of welding containers that can be manufactured using the additive manufacturing process described above. For example, FIGS. 10-13 illustrate a welding container 300. As shown, the exothermic welding container 300 has a crucible 302, a weld cavity 304, a tap hole 306 extending between the crucible 302 and the weld cavity 304, and a set of channels here shown as a first channel 308 and a second channel 310.

As mentioned above, the welding container 300 can be formed through a three-dimensional printing process such as, for example, binder jetting. Binder jetting is an additive manufacturing process that deposits a liquid binding agent onto a layer of powder particles (e.g., sand, ceramics, graphite, metal, or composites) to build a part layer-by-layer. This manufacturing process permits the forming of the welding container 300 as a singular, unitary, piece, according to a predetermined design, without requiring the extra step of removing material to form the internal negative features. Further, particular geometries may be possible with additive manufacturing (e.g., for single-piece or vertical split molds) that may not be possible with other approaches.

In some examples, it can be preferable to form the welding container 300 from a material that can be broken after the welding process takes place (e.g., ceramic, graphite, etc.). This form of welding container can be referred to as a single-use or "one-shot" mold, whereby after the welding process is complete, an operator can smash the welding container with a hammer, for example, to break the welding container to expose the weld and welded joint. However, multi-use configurations of the welding containers formed from suitable materials (e.g., graphite or other carbon based material) are also contemplated.

In some examples, a welding container can be a one-piece welding container, or integral container, as manufactured or used. This can be useful when welding a joint between two conductors with free ends that can be inserted through the two channels. However, in some scenarios it may be preferable to have a multi-piece design. For example, the welding container 300 is shown as a two-piece design split along a longitudinal direction of the first and second channels 308, 310 to form a first container piece 334 (e.g., mold piece) and a second container piece 338. The container pieces 334, 338 can be separated to receive one or more conductors, and can be assembled together for a welding operation.

In the illustrated example, container pieces 334, 338 are separable along a horizontal split plane 344, and thus form a horizontal split welding container 300. Correspondingly, in this and other examples, the first container piece 334 is a lower container piece and the second container piece 338 is an upper container piece. Further, in some examples, either of the first container piece 334 or the second container piece 338 can be integrally formed.

A two-piece (or other multi-piece) mold can be advantageous in situations in which at least one of the electrical conductors to be welded is already terminated at a termination point or otherwise installed so as to be prevented from a “stabbing” insertion through the relevant channel 308, 310. This allows the welding container 300 to be placed at any point along the at least one electrical conductor. If not split, an operator would need to disconnect the at least one electrical conductor from the termination point. Correspondingly, in an open configuration of the welding container 300, the first weld cavity portion 336 and the second weld cavity portion 340 are open to receive one or more corresponding conductors.

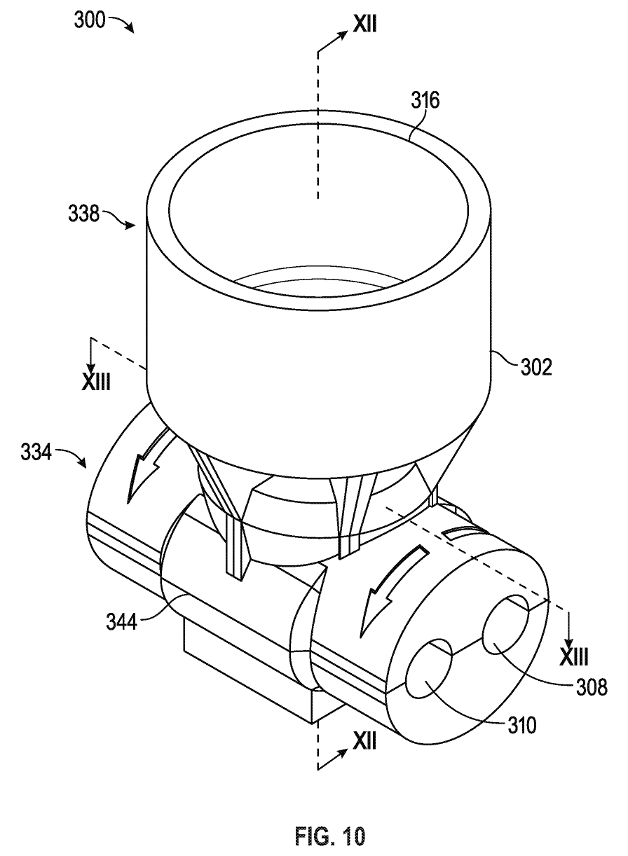

Creating a two-piece welding container as shown can be accomplished by molding the two pieces individually or by cutting, or otherwise splitting, a one-piece welding container at the preferred location after it is formed (e.g., in either case with the piece(s) formed using additive manufacturing). In some examples, the welding container 300 is cut horizontally across the set of channels, as shown. In other words, a split plane for a multi-piece welding container can intersect one or more conductor channels in some cases. In some examples, one or more of such intersected conductor channels may be substantially vertical, or may be in a “T” or other non-parallel configuration with one or more other conductor channels. In some examples of a horizontally split weld container, in particular, the conductor channels are parallel conductor channels (e.g., as shown in FIG. 11). However, it should be noted that other configurations of the channels in a horizontal split weld container are contemplated.

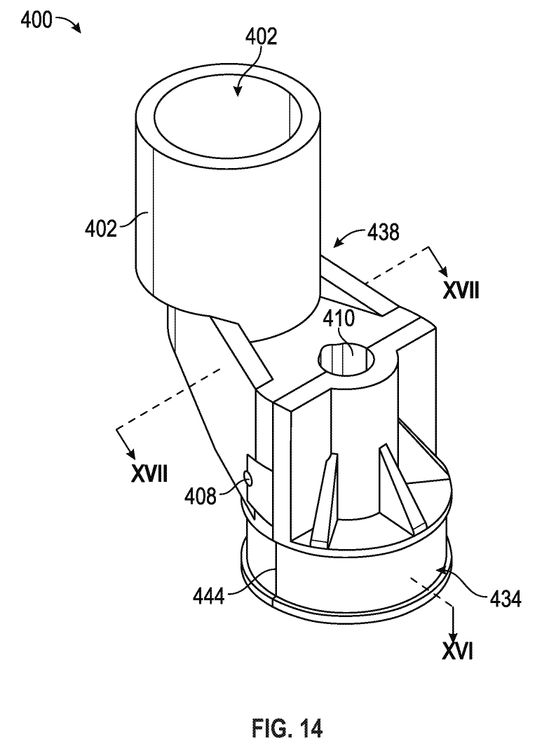

In other examples, a welding container can be cut vertically along a vertical split plane (e.g., a welding container 400 as shown in FIGS. 14 through 17 and discussed further below). In examples cut along a vertical split plane, the conductor channel(s) may be substantially horizontal, substantially vertical, or in a “T” configuration or other non-parallel configuration. In some examples of a vertically split weld container, the conductor channels are parallel conductor channels. However, it should be noted that other configurations of the channels in a vertical split weld are contemplated. In some examples, a welding container can be separable along multiple split planes (e.g., an integrally formed welding container can be cut along both horizontal and vertical split planes).

It should be understood that other configurations of the set of channels are contemplated. For example, the channels can be arranged in a parallel formation as shown, a "T" formation, a “plus” or cross formation, or other formations as determined necessary for the items to be welded together. Further, in some examples the set of channels can have channels of different dimensions (i.e., diameters, heights, widths, etc.) or shapes (e.g., circular or rectangular cross-sections) depending on the items being joined through the welding process.

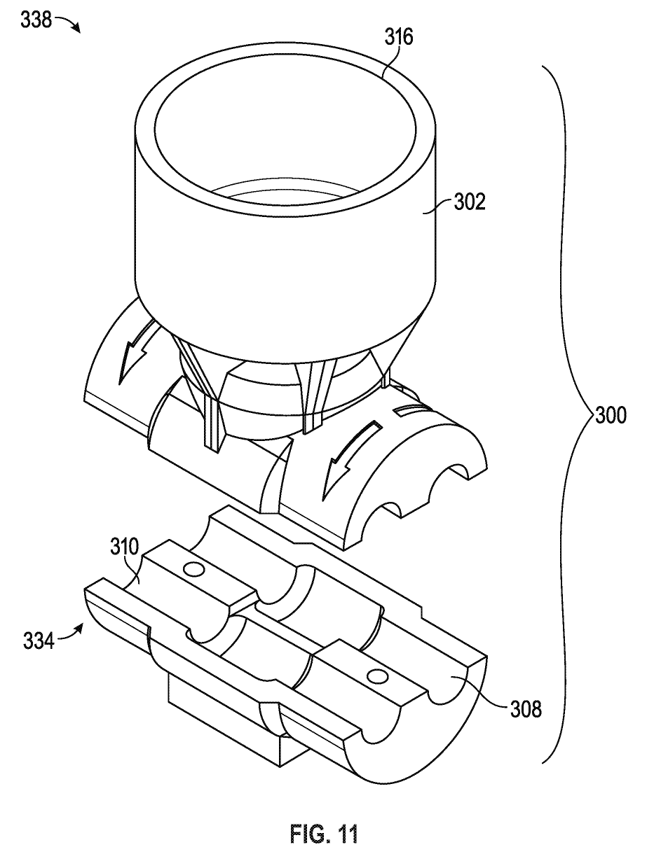

Looking at FIG. 12, a cross-section of the welding container 300 is shown. The first container piece 334 includes a first weld cavity portion 336. The second container piece 338 includes a second weld cavity portion 340, a tap hole 306, and the crucible chamber 302. The first weld cavity portion 336 and second weld cavity portion 340, in an assembled configuration, define the weld cavity 304. The crucible chamber 302 is provided in an upper portion of the welding container 300. The crucible chamber 302 tapers inward as it approaches the tap hole 306, which 306 extends from a lower end of the crucible chamber 302. The inward taper of the crucible chamber 302 enables the molten material to move more by gravity easily toward and into the tap hole 306.

In the illustrated example, the tap hole 306 is cylindrical with a constant diameter. In particular, the tap hole 306 has a tap hole width (e.g., diameter) 312, that is smaller than a width (e.g., diameter) 314, of an opening 316 of the crucible chamber 302 that can receive welding material. Generally, the size difference may aid in the separation of the molten copper and the slag as they travel down to the weld cavity 304 due to their different densities. Other configurations of the tap hole 306 are contemplated, however, including, for example, a tapered design that may narrow or widen closer to the weld cavity 304.

Continuing, the second weld cavity portion 340 is shown having a riser (e.g., top) section 318, and a lower (e.g., bottom) section 320. In the illustrated example, the top section 318 has a trapezoidal cross-sectional shape, relative to a vertical plane (e.g., a centerline plane, as shown). The trapezoidal cross-section defines a set of parallel bases, including a first base 322, with a first base width 324, or a first weld width, and a second base 326, with a second base width 328, or a second weld width 328, and a set of non-parallel legs, including a first leg 330 and a second leg 332. As shown, the trapezoid shape of the top section 318 is inverted with the first base width 324 being greater than the second base width 328, the first base 322 positioned adjacent the tap hole 306, and the second base 326 positioned adjacent the bottom section 320. More generally, a riser section can exhibit a horizontal cross section with a width that increases over a vertical rise, including as shown for the weld cavity 304 and detailed above. In the illustrated example, the vertical rise can correspond an axial direction of the tap hole 306, extending away from the bottom section 320. In some examples, the first and second legs 330, 332 can extend at an angle of about 85 degrees from the first base 322 toward the second base 326, relative to horizontal (or about 15 degrees relative to vertical). However, other angles are contemplated.

Generally, the larger width and cross-sectional area of the weld cavity 304 toward a top of a riser (e.g., adjacent the tap hole 306) provides a space for slag to easily collect away from the copper (or other molten metal). Correspondingly, the copper can more easily settle in the bottom section 320 and the first weld cavity portion 336 to form the desired weld. In some examples, the interface between the top section 318 and the bottom section 320 can be a demarcation between the copper weld material and the slag.

Further, the inverted expansion of the top section 318 provides more space for slag to collect away from the conductors than a weld cavity with vertical or inwardly tapered sides, without requiring an increase in the height of the weld cavity 304, and thus in the overall height of the welding container 300. The corresponding reduction in height of the weld cavity 304 relative to conventional containers, for a given weld volume, can reduce the material and time required for manufacturing the welding container and can therefore lower the manufacturing cost per unit. In other examples, similarly inverted riser configurations are possible, with other particular geometries (e.g., with circular horizontal cross-sections), with similar beneficial effects stemming from the inclusion of a riser cross section that becomes generally wider, moving from the relevant conductor channels, along a vertical rise, toward the tap hole.

The second weld cavity portion 340 of the weld cavity 304 is shown having a generally rectangular cross-sectional shape (along the horizontal sectional plane), which reduces in cross-sectional size in the direction toward the bottom section 320 and the first weld cavity portion 336 of the first container piece 334 (i.e., in an opposite direction from a vertical rise).

As stated above, the bottom section 320 and the first weld cavity portion 336 can collectively define a shape of the weld to be formed. Correspondingly, the bottom section 320 or the first weld cavity portion 336 can be configured in a wide variety of shapes to provide a desired weld. In some configurations, indicia can be inset within the bottom section 320 or the first weld cavity portion 336.

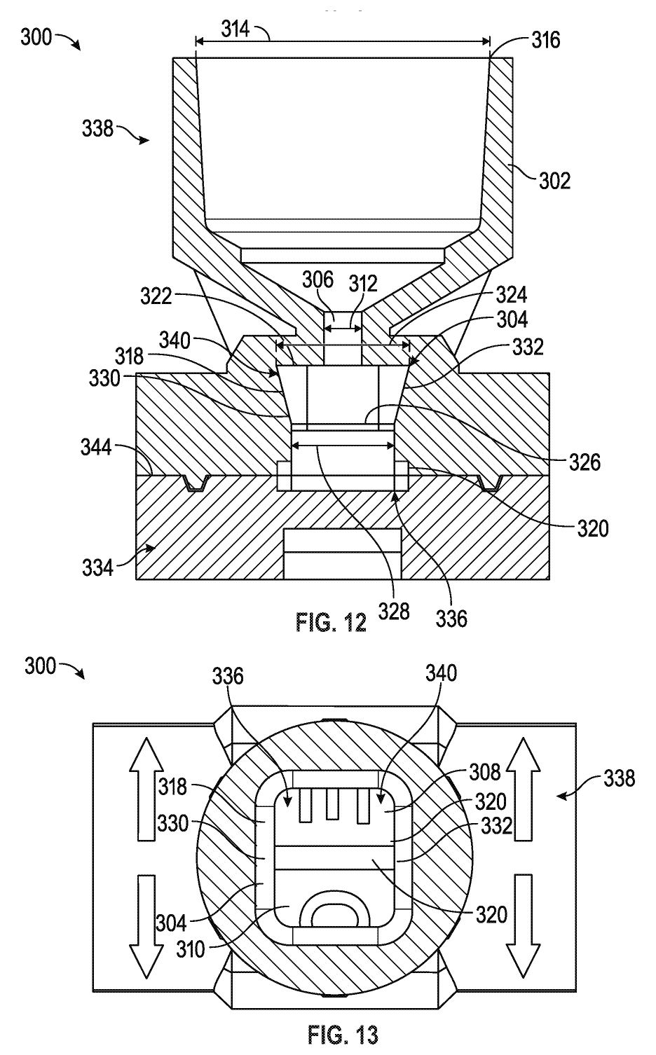

In some examples, other configurations of a weld cavity are contemplated. For example, a weld cavity can get wider over a vertical rise from a bottom section, then narrower, and then wider again to define a shape of the weld cavity with a wider mid-section (e.g., a diamond or bulbous cross-sectional shape) as viewed from a cross-sectional view similar to FIG. 12. Further, when viewed from a direction as shown in FIG. 13, the cross-sectional shape of a weld cavity can be round (e.g., circular or oval), triangular, or a shape having more than four sides. Continuing, in some examples, the cross-sectional shape can transition from shape to shape along the width of the weld cavity (e.g., rectangular to round or round to rectangular).

FIGS. 14 through 17 illustrate another example of a welding container 400 according to the disclosure, and also can be used to form a weld on a set of electrical conductors or other objects. In many aspects, the welding container 400 is similar to the welding container 300 described above and similar numbering in the 400 series is used for the welding container 400. For example, the welding container 400 has a crucible chamber 402, a weld cavity 404 with a riser (e.g., top) section 418 and a lower (e.g., bottom) section 420, and a tap hole 406 extending between the crucible chamber 402 and the weld cavity 404. The tap hole 406 has a tap hole width that is smaller than a width of an opening of the crucible chamber 402.

In the illustrated example, the welding container 400 includes a first container piece 434 and a second container piece 438. Further, in some examples, one or more of the first container piece 434 or the second container piece 438 can be integrally formed.

The weld cavity 404 includes a first weld cavity portion 236 and a second weld cavity portion 440. In particular, the first weld cavity portion 436is partly defined by protrusions from the first container piece 434 that nest into the second container piece 438. The protrusions also include a corresponding part of the channel 408, which correspondingly offsets the channel 408 laterally apart from the channel 410. However, other configurations are possible.

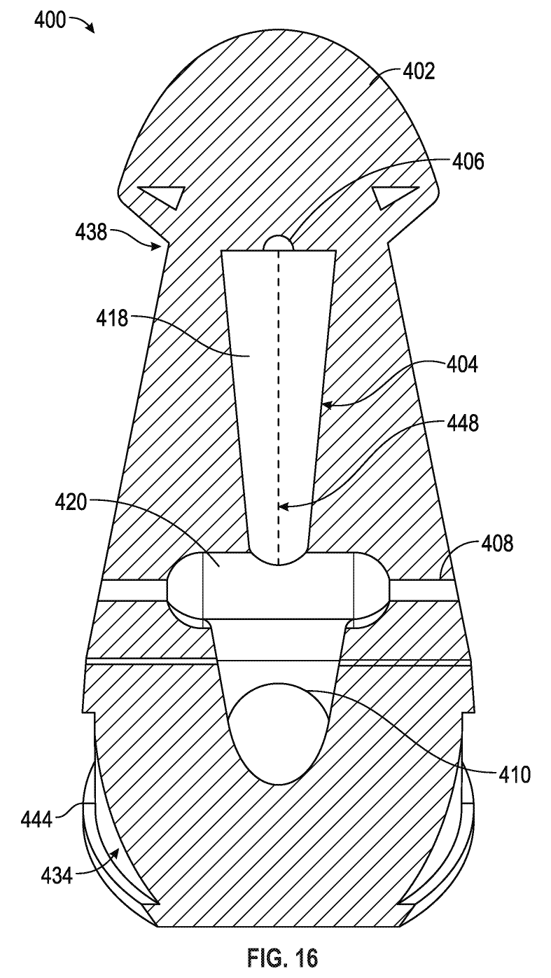

Similarly to the weld cavity 304, and as shown in FIG. 16 in particular, the lower section 420 of the weld cavity 404 can receive conductors to be welded together, and the riser section 418 can increase in cross-sectional area (and width) in a direction moving away from the lower area. The riser 418 also exhibits an inverted trapezoid-shaped cross-section, as shown in FIG. 16.

Further, the welding container 400 as shown is a two-piece design, with the first container piece 434 and a second container piece 438 being separable (e.g., and also cut apart) to receive one or more conductors. In particular, the pieces 434, 438 are separable along a vertical split plane 444, and accordingly form a vertical split welding container. However, it is contemplated that other examples may be one-piece containers, may include more than two pieces, or may have other split geometries.

In the illustrated example, because the welding container 400 is a split container, the welding container 400 can be more flexibly placed at a desired welding location along the at least one electrical conductor. For example, in an open configuration of the welding container 400, the first weld cavity portion and the second weld cavity portion 440 are open to receive one or more conductors. Additionally, in an assembled configuration, the first and second container pieces 434, 438 align such that the first and second weld cavity portions collectively define the weld cavity 404 to contain molten metal received from the crucible 416 via the riser 418 to form the desired weld.

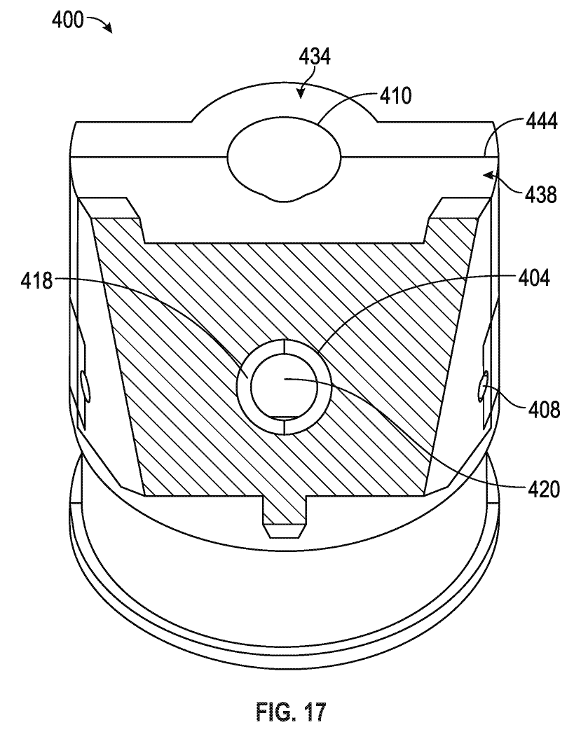

In other aspects, the welding containers 300, 400 also differ from each other. For example, the riser section 418 has a circular cross-sectional shape perpendicular to a centerline thereof, as shown in FIG. 17. Therefore, the overall shape of the weld cavity 404 is a circular cone. However, it is contemplated that other examples of the disclosure include a weld cavity 404 that is trapezoidal. Additionally, first and second channels 408, 410 extend transverse to each other. For instance, in a preferred example, the second channel 410 is arranged to be a substantially vertical channel and the first channel 408 is arranged to be a substantially horizontal channel (e.g., the second channel is perpendicular to the first channel).

Continuing, the first and second channels 408, 410 are laterally offset from the crucible chamber 402 and the tap hole 406. Correspondingly, in the illustrated example, the weld cavity 404 extends along an angle defined by a centerline 448, as shown in FIG. 16. In some examples, the angle defined by the centerline 448 is greater than zero relative vertical (e.g., relative to a central axis of the crucible chamber 402 and the tap hole 406). In other words, the centerline 448 may extend obliquely relative to vertical. In some examples, the angle defined by the centerline 448 is substantially identical. In other examples, the angle defined by the centerline 448 is perpendicular to the cross-sectional plane of FIG. 16. However, other variations of the angle defined by the centerline 448 are contemplated. With the offset configuration, for example, the second channel 410 can receive a ground rod vertically therethrough without interference from the crucible chamber 402, the tap hole 406, or the riser section 418 of the weld cavity 404. The welding container 400 is also configured to receive an electrode conductor within the first channel 408 to facilitate the exothermic welding of the electrode conductor to the ground rod.

In other examples, other configurations of a welding container are contemplated. For example, a welding container can include differently configured conductor passages to accommodate various components to be welded. In some instances, welding containers may be configured to weld cables, e.g., conductors. Further, in some cases, welding containers may be configured to weld cables that are parallel to one another. For example, in the example configuration shown in FIGS. 10-13, the welding container may be configured to weld cables that are in parallel with one other, as previously discussed. Other welding containers may be configured to weld cables together that are not in parallel. For the example, in the configuration shown in FIGS. 14-17, a welding container may be used to weld tables together that are perpendicular or otherwise oblique relative to each other (e.g., in a “T” configuration), including as previously discussed.

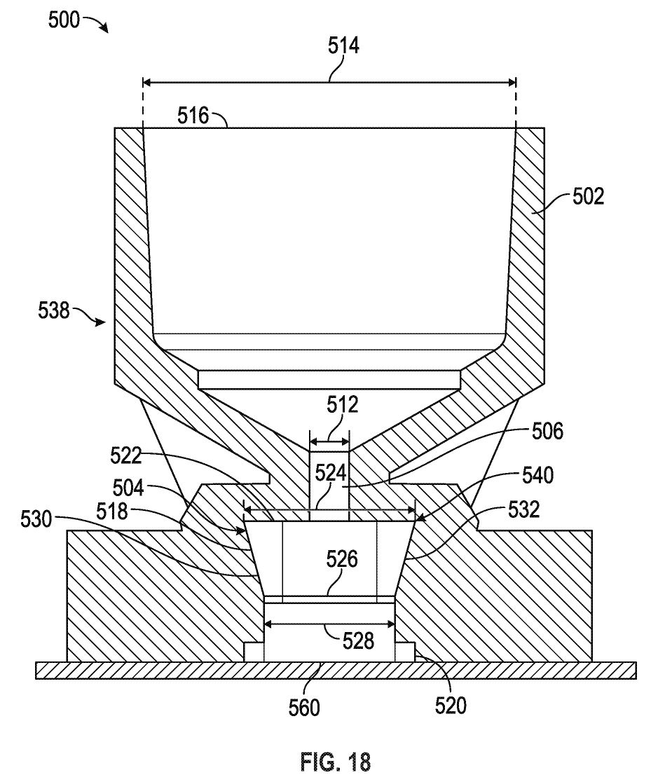

In other instances, welding containers may be configured to weld other metal conductors together. For example, it may be advantageous for a welding container to be configured to weld one or more flat conductors, or to weld one or more conductors to a flat (e.g., horizontal) surface. In this regard, for example, FIG. 18 illustrates another example of a welding container 500 according to some aspects of the disclosure, which can be used to form a weld on a set of electrical conductors or other objects. In particular, FIG. 18 displays a cross-sectional view similar to the view of FIG. 12 for the welding container 500.

In many aspects, the welding container 500 is similar to the welding container 300 described above and similar numbering in the 500 series is used for the welding container 500. For example, the welding container 500 as illustrated includes a welding container piece 538 that defines internal features to contain an exothermic reaction of weld material, convey the resulting molten metal to a weld chamber, and retain the metal in the weld chamber to weld together conductors. In particular, the welding container piece 538 has a crucible chamber 502, a weld cavity 504 with a riser (e.g., top) section 518, and a lower (e.g., bottom) section 520, and a tap hole 506 extending between the crucible chamber 502 and the weld cavity 504. The tap hole 506 has a width 512 that is smaller than a width 514 of an opening 516 of the crucible chamber 502.

The weld cavity 504 is also configured to have an inverted configuration, similar to the weld cavity 304 of FIG. 10. The weld cavity 504 can be at least partly formed by a weld cavity portion 540 defined by the welding container piece 538.

As shown in FIG. 18, the top section 518 may be have a trapezoidal shape along a vertical sectional plane, or may be otherwise inverted to have increasing width over a vertical rise. In such examples, the trapezoid shape of the top section 518 is inverted with a first base width 524 being greater than the second base width 528, as measured for the first base 522 adjacent the tap hole 506, and for the second base 526 adjacent the bottom section 520. Thus, as generally noted above, the weld cavity 504 has a width that increases over a vertical rise (e.g., as may extend along a centerline of the riser section 518 away from the bottom section 520.

In some aspects, however, the example welding container 500 may differ from the welding container 300. For example, the welding container 500 may be used to form a weld on a flat surface 560. As shown in the example configuration of FIG. 18, the flat surface 560 may be a top surface of a flattened electrical conductor, including a grounding plate, a bus bar, or various other types of conductors. Correspondingly, a conductor passage through the container 500 (e.g., aligned with the bottom section 520) can intersect with the weld cavity 504 to allow a conductor of various configurations to be welded to the flat surface 560 within the weld cavity 504.

Generally, the welding container 500 may include one or more channels that allow one or more conductors of various configurations (e.g., flat conductors) to be inserted into the welding container 500. In particular, one or more channels can intersect with the weld cavity 504 to allow a conductor of various configurations to be welded to the flat surface 560 within the weld cavity 504 (e.g., with a channel aligned with the bottom section 520). As also discussed above, the channel(s) may be horizontal, vertical, parallel, non-parallel or otherwise configured.

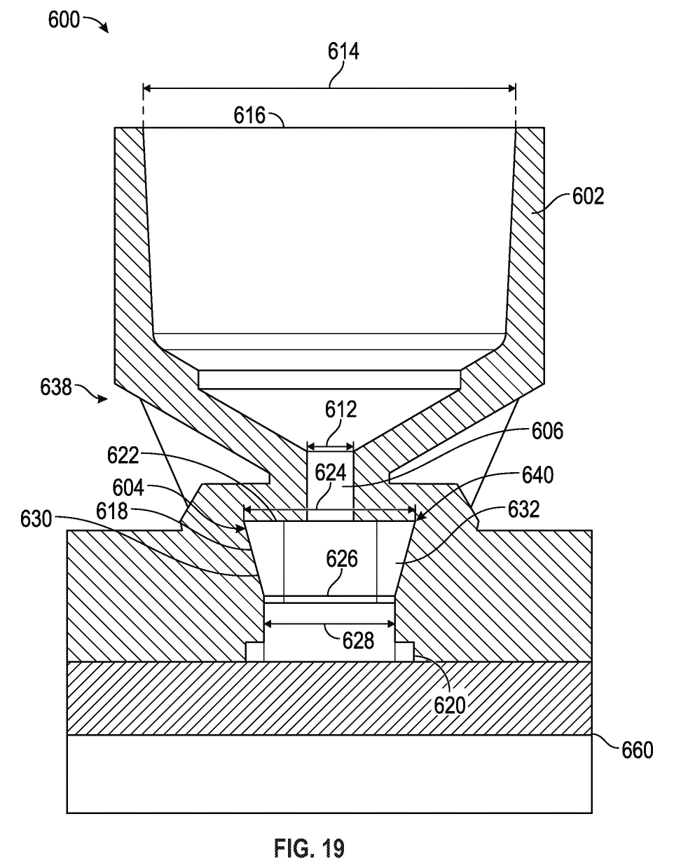

In other instances, welding containers may be configured to weld together components to a pipe, post, or other components with a curved profile. In this regard, FIG. 19 illustrates another example of a welding container 600 according to some aspects of the disclosure, and can be used to form a weld on a set of electrical conductors or other objects. FIG. 19 displays a cross-sectional view of an example configuration of a welding container that is horizontally split, similar to the welding container 300.

In many aspects, the welding container 600 is similar to the welding container 300 described above and similar numbering in the 600 series is used for the welding container 600. For example, the welding container 600 has a weld container piece 638 that defines a crucible chamber 602, and a weld cavity portion 640 of a weld cavity 604 that includes an inverted riser (e.g., top) section 618 and a lower (e.g., bottom) section 620. A tap hole 606 extends between the crucible chamber 602 and the weld cavity 604.

The tap hole 606 has a width 612 that is smaller than a width 614 of an opening 616 of the crucible chamber 602. As noted above, the riser section 618 defines an inverted trapezoid-shaped cross-section, similar to the weld cavity 304 of FIG. 10. In particular, the top section 618 includes a first base 622 with a first, wider base width 624 adjacent the tap hole 606, and a second base 626 with a second, narrower base width 628 adjacent the bottom section 620. A set of non-parallel legs, including a first leg 630 and a second leg 632, extend between the bases 622, 626.

The welding container 600 is shown with the weld container piece 638 to securing a pipe wall 660 or other curved component in communication with the weld cavity 604. It is contemplated that the welding container 600 may be one-piece or a two-piece design.

Generally, the welding container 600 may include one or more channels that allow one or more conductors of various configurations (e.g., flat or rounded conductor) to be inserted into the welding container 600. In particular, one or more channels can intersect with the weld cavity 604 to allow a conductor of various configurations to be welded to the pipe wall 660 or other component within the weld cavity 604 (e.g., with a channel aligned with the bottom section 620). As also discussed above, the channel(s) may be horizontal, vertical, parallel, non-parallel or otherwise configured.

Thus, examples of the disclosure can provide an improved weld cavity configuration for exothermic welding systems. For example, the inverted configuration of a riser section can aid in more efficiently and effectively separating the slag from the molten copper to ensure a better more consistent weld.

In some implementations, devices or systems disclosed herein can be manufactured, utilized, or installed using methods embodying aspects of the disclosure. Correspondingly, description herein of particular features or capabilities of a device or system is generally intended to inherently include disclosure of a method of manufacturing or using such features for intended purposes and of implementing such capabilities. Similarly, express discussion of any method of using a particular device or system, unless otherwise indicated or limited, is intended to inherently include disclosure, as examples of the disclosed technology, of the utilized features and implemented capabilities of such device or system.

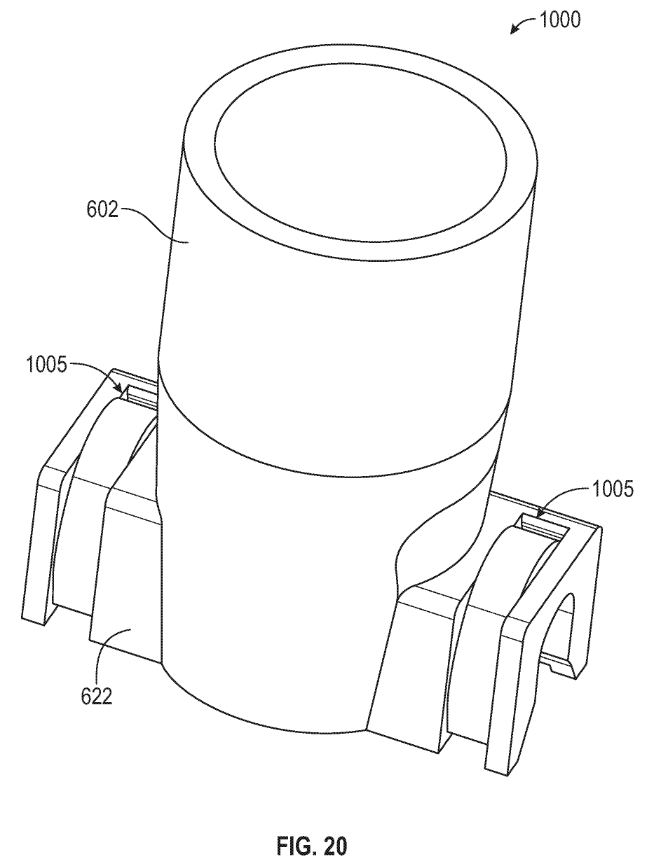

FIGS. 20-23 illustrate another example of an exothermic welding container 1000 manufactured via the additive manufacturing process as described above. As will be recognized, the exothermic welding container 1000 shares a number of components in common with and operates in a similar fashion to the examples illustrated and described previously (e.g., the exothermic welding container 100, 300, 400, etc.). For the sake of brevity, these common features will not be again described below in detail. Rather, previous discussion of commonly named or numbered features, unless otherwise indicated, also applies to example configurations of the exothermic welding container 1000.

As with the previously described exothermic welding containers 100, 300, and 400, the exothermic welding container 1000 can be manufactured using the additive manufacturing process described above with reference to FIG. 6, wherein layers of base material (e.g., silica sand, ceramic material, or graphite fines) are successively deposited and fused with a binder to form the three-dimensional container structure. As shown in these figures, the exothermic welding container 1000 includes a crucible chamber 602 positioned in an upper portion of the container and configured to receive weld material, along with a base 622 extending from a lower portion of the container.

In some examples, the exothermic welding container 1000 can include a retention system 1005 that is integrally formed during the additive manufacturing process, providing a mechanism for securing the container to conductors or other components during welding operations. As illustrated in FIGS. 20-23, the retention system 1005 can be positioned on a lower portion of the exothermic welding container 1000 and can extend outwardly from the body of the container on both sides adjacent to the first channel 308 and the second channel 310. In some examples, the retention system 1005 can include slots or openings that are configured to receive fastening elements, such as zip ties or similar flexible fasteners, which can be threaded through the slots and wrapped around the conductors to hold the exothermic welding container 1000 in a fixed position relative to the conductors during the exothermic welding reaction.

In some examples, a first conductor 1010 is positioned within the first channel 308 and a second conductor 1015 is positioned within the second channel 310, with the retention system 1005 on both sides of the container to facilitate securing the container to the conductors. In some examples, the container 1000 defines an opening 1020 in a lower portion of the container. The opening 1020 includes chamfered edges 1025 that provide a tapered entry surface to facilitate insertion of conductors into a slot 1030.

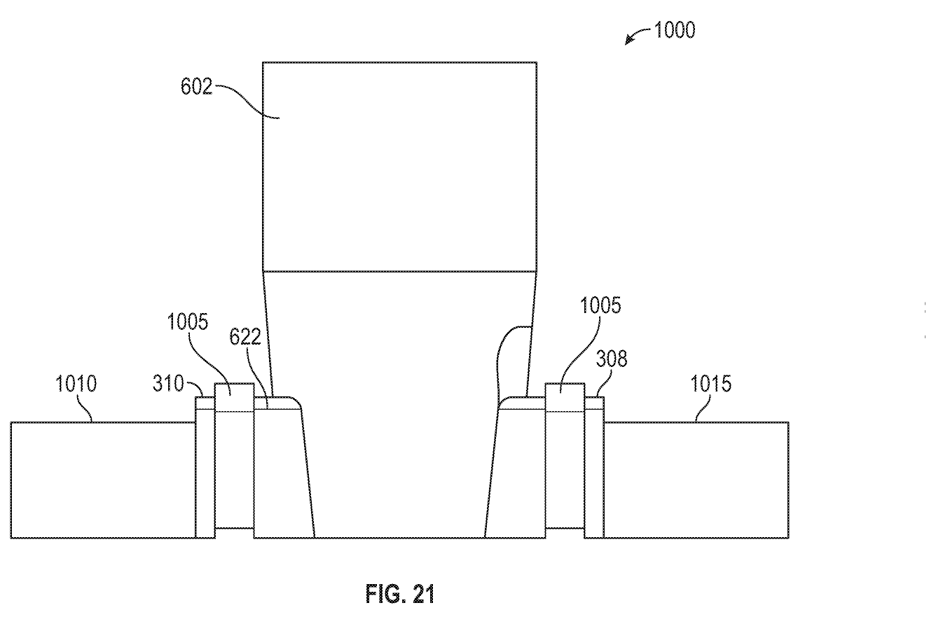

In some examples, the exothermic welding container 1000 can be configured as a cable-to-cable welding container, wherein the first channel 308 and the second channel 310 are arranged in a parallel configuration to receive two conductors that extend in substantially the same direction. As shown in FIG. 21, the first conductor 1010 and the second conductor 1015 are positioned in a parallel arrangement, with both conductors extending horizontally through their respective channels on opposite sides of the container. This configuration is suitable for splicing or joining two cable conductors end-to-end or in a parallel run configuration. The parallel arrangement of the channels 308, 310 allows the conductors to be welded together within the weld cavity, forming a continuous electrical connection between the two cables.

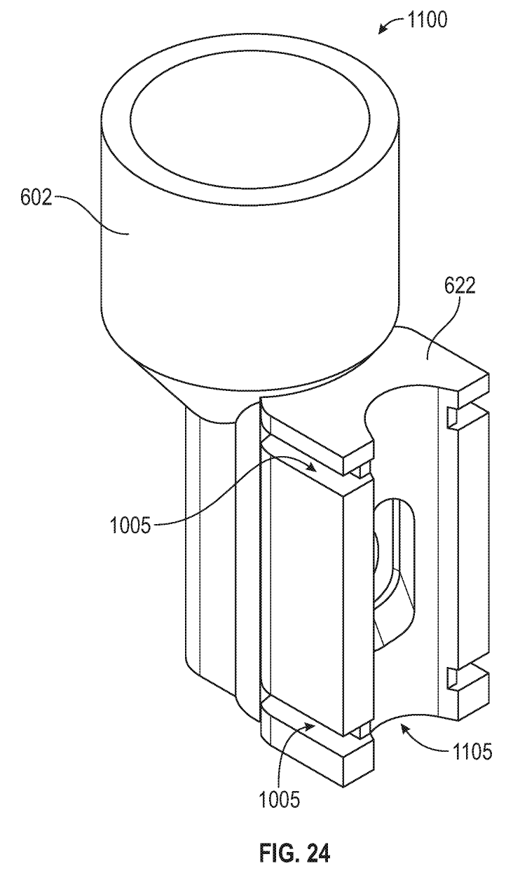

FIGS. 24-27 illustrate another example of an exothermic welding container 1100 manufactured via the additive manufacturing process as described above. As will be recognized, the exothermic welding container 1100 shares a number of components in common with and operates in a similar fashion to the examples illustrated and described previously (e.g., the exothermic welding container 100, 300, 400, 1000 etc.). For the sake of brevity, these common features will not be again described below in detail. Rather, previous discussion of commonly named or numbered features, unless otherwise indicated, also applies to example configurations of the exothermic welding container 1100.

In contrast to the exothermic welding container 1000 of FIGS. 20-23, which is configured for cable-to-cable splice connections where conductors extend horizontally through channels on opposite sides of the container, the exothermic welding container 1100 of FIGS. 24-27 is configured for a different use case. As shown in FIGS. 24-27, the exothermic welding container 1100 includes an opening 1105 in a lower portion of the container and an aperture 1110 positioned along the base 622, providing a configuration suited for cable-to-ground rod or cable-to-vertical-conductor connections where one conductor extends vertically through the container.

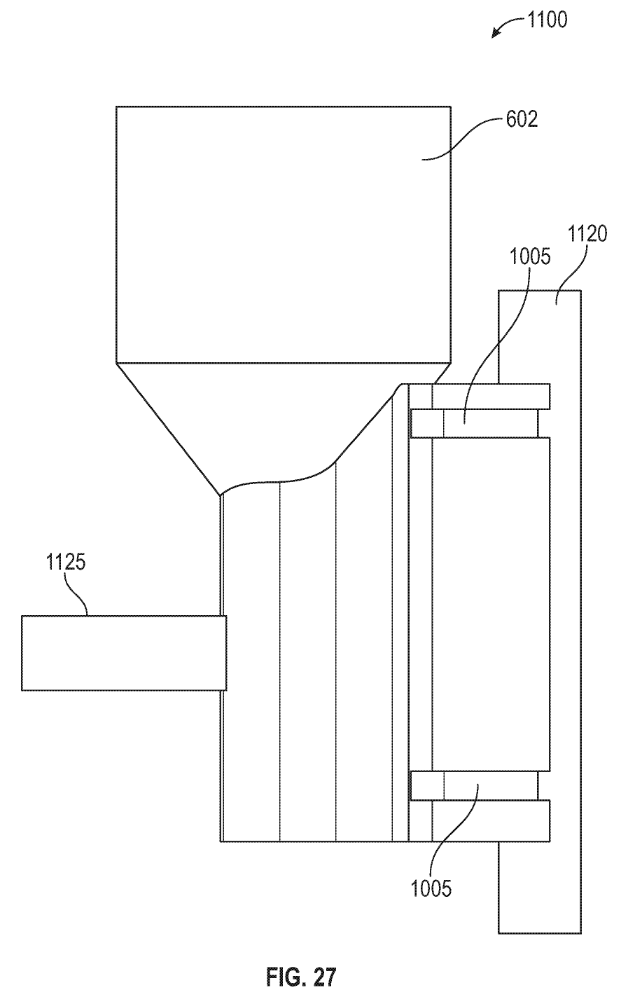

As shown in FIG. 27, a first conductor 1120 and a second conductor 1125 extend from opposite sides of the exothermic welding container 1100, positioned to be welded together within the weld cavity 1115. In some examples, the first conductor 1120 and the second conductor 1125 can be arranged in a perpendicular or transverse orientation relative to each other, with the first conductor 1120 extending horizontally through the aperture 1110 and the second conductor 1125 extending vertically through the opening 1105. This perpendicular arrangement allows the exothermic welding container 1100 to accommodate cable-to-ground rod or cable-to-vertical-conductor connections where conductors approach the weld cavity 1115 from different directions. The retention system 1005 is configured to secure the exothermic welding container 1100 to the conductors during welding operations. In some examples, the retention system 1005 can be used to secure the first conductor 1120 within the opening 1105, maintaining the first conductor 1120 in a fixed position relative to the weld cavity 1115 during the exothermic welding process. The retention system 1005 can include features that engage with or clamp against the first conductor 1120 to prevent movement or displacement of the conductor during the exothermic reaction, thereby facilitating proper alignment and contact between the first conductor 1120 and the second conductor 1125 within the weld cavity 1115 to form a reliable electrical connection.

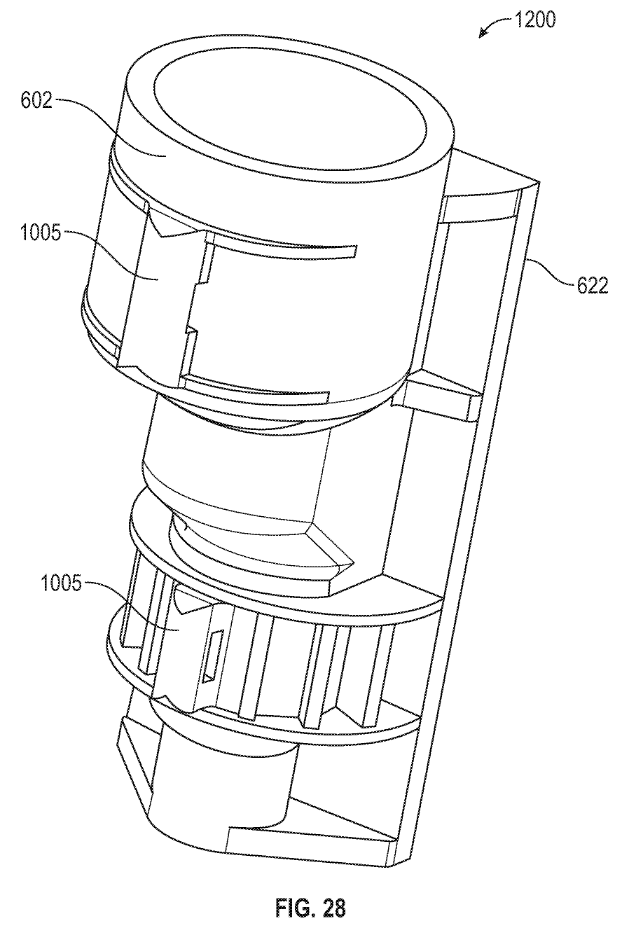

FIGS. 28-31 illustrate another example of an exothermic welding container 1200 manufactured via the additive manufacturing process as described above. As will be recognized, the exothermic welding container 1200 shares a number of components in common with and operates in a similar fashion to the examples illustrated and described previously (e.g., the exothermic welding container 100, 300, 400, 1000, 1100, etc.). For the sake of brevity, these common features will not be again described below in detail. Rather, previous discussion of commonly named or numbered features, unless otherwise indicated, also applies to example configurations of the exothermic welding container 1200.

In some examples, the exothermic welding container 1200 can be configured for cable-to-pipe connections, such as welding a cable to a larger diameter pipe. As shown in FIGS. 28-31, the exothermic welding container 1200 includes an aperture 1205 and a flange. The flange is configured to rest against (e.g., receive) a first conductor 1215, while the aperture 1205 is configured to receive a second conductor 1220. In some examples, the first conductor 1215 and the second conductor 1220 can extend parallel (e.g., in a vertical orientation). This configuration allows the exothermic welding container 1200 to accommodate connections where a cable approaches a pipe or larger diameter conductor from a vertical direction. The weld cavity 1210 is positioned to facilitate proper contact and fusion between the conductors during the exothermic welding process. The crucible chamber 602 is positioned above the weld cavity 1210, and the tap hole 606 provides a passage for molten metal to flow from the crucible chamber 602 into the weld cavity 1210 to join the first conductor 1215 and the second conductor 1220. The retention system 1005 is positioned at multiple locations along the container body to secure the exothermic welding container 1200 during welding operations.

Thus, the exothermic welding containers 1000, 1100, and 1200 illustrate different configurations suited for different welding applications. The exothermic welding container 1000 of FIGS. 20-23 is configured for cable-to-cable splice connections with parallel horizontal conductors. The exothermic welding container 1100 of FIGS. 24-27 is configured for cable-to-ground rod or cable-to-vertical-conductor connections with perpendicular conductor orientations. The exothermic welding container 1200 of FIGS. 28-31 provides a configuration for cable-to-pipe connections, such as welding a cable to a larger diameter pipe. Each of these configurations can be manufactured using the additive manufacturing process described above, allowing for economical production of welding containers tailored to specific welding applications without requiring specialized tooling for each configuration.

The use herein of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

Also as used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as “either,” “one of,” “only one of,” or “exactly one of.” For example, a list of “one of A, B, or C” indicates options of: A, but not B and C; B, but not A and C; and C, but not A and B. A list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more of A, one or more of B, and one or more of C. Similarly, a list preceded by “a plurality of” (and variations thereon) and including “or” to separate listed elements indicates options of multiple instances of any or all of the listed elements. For example, the phrases “a plurality of A, B, or C” and “two or more of A, B, or C” indicate options of: A and B; B and C; A and C; and A, B, and C.

Also as used herein, unless otherwise limited or specified, “substantially identical” refers to two or more components or systems that are manufactured according to the same process and specification, with variation between the components or systems that are within the limitations of acceptable tolerances for the relevant process or specification. For example, two components can be considered to be substantially identical if the components are manufactured according to the same standardized manufacturing steps, with the same materials, and within the same acceptable dimensional tolerances (e.g., as specified for a particular process or product).

The previous description of the disclosed examples is provided to enable any person skilled in the art to make or use the disclosed technology. Various modifications to these examples will be readily apparent to those skilled in the art, and the generic principles defined herein may be applied to other examples without departing from the spirit or scope of the disclosed technology. Thus, the disclosed technology is not intended to be limited to the examples shown herein but is to be accorded the widest scope consistent with the principles and novel features disclosed herein.

1. A method of producing exothermic welding systems, the method comprising:
providing a digital model of an exothermic welding container to an additive manufacturing system;
forming the exothermic welding container using the additive manufacturing system by, for a plurality of layers:
depositing a layer of a base material with a shape based on the digital model; and
using a phenolic resin binder to fuse the layer of the base material in the shape provided to form a corresponding part of the exothermic welding container.

2. The method of claim 1, wherein the exothermic welding container includes a sidewall structure defining a welding chamber and a crucible chamber, and wherein the exothermic welding container further includes at least one channel that extends through the sidewall structure and into the welding chamber.

3. The method of claim 1, wherein the base material is a silica sand;
wherein the phenolic resin binder includes a furfuryl alcohol; and
wherein fusing the layer of the base material includes a polymerization reaction of the furfuryl alcohol with an acid applied to the base material.

4. The method of claim 1, wherein the base material is a ceramic material.

5. The method of claim 1, wherein the base material is a carbon-based material, including graphite fines; and
wherein using the phenolic resin binder to fuse the layer of the base material includes spraying the phenolic resin binder onto the base material.

6. The method of claim 1, wherein for each layer of the plurality of layers, the additive manufacturing system applies the phenolic resin binder to a plurality of regions of the base material to fuse layers for a plurality of exothermic welding containers.

7. The method of claim 1, wherein the exothermic welding container is formed to include one or more level markers in a riser portion corresponding to one or more fill-levels for weld material.

8. The method of claim 1, wherein the exothermic welding container is formed as a plurality of interlocking pieces.

9. The method of claim 1, wherein the exothermic welding container includes a weld cavity having a riser section with an inverted trapezoidal cross-sectional shape, wherein a width of the riser section increases over a vertical rise moving away from a lower section of the weld cavity toward a tap hole.

10. The method of claim 9, wherein the riser section includes a first base positioned adjacent the tap hole and a second base positioned adjacent the lower section, wherein a first base width of the first base is greater than a second base width of the second base.

11. The method of claim 1, wherein the exothermic welding container includes a retention system integrally formed during the forming, the retention system configured to secure the exothermic welding container to conductors during welding operations.

12. The method of claim 11, wherein the retention system includes slots or openings configured to receive fastening elements.

13. The method of claim 1, wherein the exothermic welding container is configured as a cable-to-cable welding container, wherein a first channel and a second channel are arranged in a parallel configuration to receive two conductors that extend in substantially the same direction.

14. The method of claim 1, wherein the exothermic welding container is configured for cable-to-ground rod connections, wherein a first conductor and a second conductor are arranged in a perpendicular or transverse orientation relative to each other.

15. The method of claim 14, wherein the exothermic welding container includes an aperture configured to receive a first conductor extending horizontally and an opening configured to receive a second conductor extending vertically.

16. The method of claim 1, wherein the exothermic welding container is configured for cable-to-pipe connections, wherein the exothermic welding container includes a flange configured to rest against a first conductor and an aperture configured to receive a second conductor.

17. The method of claim 1, wherein a radial thickness of a peripheral wall of the exothermic welding container is not constant along one or more internal chambers of the exothermic welding container.

18. The method of claim 1, wherein the exothermic welding container includes an opening with chamfered edges that provide a tapered entry surface to facilitate insertion of conductors.

19. An exothermic welding system comprising:
an exothermic welding container having a container body formed of a silica sand base material fused with a phenolic resin binder comprising furfuryl alcohol, the container body defining:
a crucible chamber configured to receive weld material;
a weld cavity positioned below the crucible chamber;
a tap hole extending between the crucible chamber and the weld cavity; and
at least one channel extending through the container body and into the weld cavity to receive a conductor.

20. A method of manufacturing an exothermic welding container, the method comprising:
generating a digital model comprising a three-dimensional representation of the exothermic welding container, the digital model defining a crucible chamber, a weld cavity, a tap hole extending between the crucible chamber and the weld cavity, and at least one conductor channel;
translating the digital model into a plurality of planar layers corresponding to successive cross-sections of the exothermic welding container;
for each planar layer of the plurality of planar layers:
depositing a base material onto a build surface, the base material including one or more of silica sand, ceramic fines, or graphite fines; and
selectively applying a phenolic resin binder to a portion of the base material in a pattern corresponding to the planar layer, the phenolic resin binder fusing the portion of the base material to form a solid layer of the exothermic welding container;
repeating the depositing and selectively applying for each successive planar layer until the exothermic welding container is formed as a unitary structure corresponding to the three-dimensional representation of the digital model; and
removing unfused base material from the formed exothermic welding container.
